(19) United States
(12) Patent Application Publication
(10) Pub. No.: US 2024/0202986 A1
(43) Pub. Date: Jun. 20, 2024

(54) SYSTEMS AND METHODS FOR CONCEPTUALIZING A VIRTUAL OR LIVE OBJECT

(71) Applicant: Rovi Guides, Inc., San Jose, CA (US)

(72) Inventor: Mona Singh, Cary, NC (US)

(21) Appl. No.: 18/084,685

(22) Filed: Dec. 20, 2022

(51) Int. Cl. G06T 11/00; G06F 3/01; G06F 3/0482; G06Q 30/0601; G06V 20/20; G06V 20/30; G06V 40/20

(52) U.S. Cl. CPC G06T 11/00; G06F 3/013; G06F 3/0482; G06Q 30/0643; G06V 20/20; G06V 20/30; G06V 40/20

(57) ABSTRACT

Systems and methods for conceptualizing an initial object by using a reference object are described. The methods identify an initial object such as a virtual object or a live object. Characteristic(s) of the initial object may be obtained and used in a search query to search for a reference object with which a user has interacted. In some instances, the characteristic(s) may be obtained upon determining an interest in the initial object. Reference objects that include the characteristic(s) and have a user interaction may be identified and scored. The reference objects, if more than one identified, may be ranked based on the score and a reference object may be selected for display. The display may include both the selected reference object and the initial object and provide context to the initial object by such that the user may be able to relate to it based on their interactions with the reference object.

### FIELD OF INVENTION

Embodiments of the present disclosure relate to conceptualizing either or both a virtual object displayed on an extended reality device, or a live object viewed through a camera of an electronic device by using a reference object to enhance the virtual or a live object.

### BACKGROUND

Extended reality (XR) devices, such as virtual reality (VR) and augmented reality (AR) headsets, allow users to interact with virtual objects displayed on the headset. Often, virtual objects are visual representations of real-life objects. For example, a user might be shopping for a piece of furniture and may use an XR system to view a virtual object of that piece of furniture in his room. This virtual object may be a photo-realistic representation of the piece of furniture, intended to look nearly identical to its real-life counterpart. In some circumstances, a virtual object may be an object having no direct (or even proximate) real-world counterpart (e.g., virtual object designed to look like a fictional spaceship that is used in a virtual experience in which the user is transported to or from an alien planet).

Although the use of such extended reality devices is on the rise, current applications that are executed on extended reality devices often fail to provide a natural way for users to conceptualize virtual objects in a useful context.

### BRIEF DESCRIPTION OF THE FIGURES

The various objects and advantages of the disclosure will be apparent upon consideration of the following detailed description, taken in conjunction with the accompanying drawings, in which like reference characters refer to like parts throughout, and in which:

FIG. 1 is a block diagram of an example of a process for enhancing an initial object with a reference object, in accordance with some embodiments of the disclosure;

FIG. 2 is a block diagram of an exemplary system for enhancing an initial object with a reference object for conceptualization, in accordance with some embodiments of the disclosure;

FIG. 3 is a block diagram of an electronic device used for receiving an input of an initial object and enhancing the initial object for conceptualization, in accordance with some embodiments of the disclosure;

FIG. 4 is a flowchart of a process for enhancing an initial object with a reference object, in accordance with some embodiments of the disclosure;

FIG. 5 is an example of an initial object, in accordance with some embodiments of the disclosure;

FIG. 6 is an example of another initial object, in accordance with some embodiments of the disclosure;

FIG. 7 is an example of characteristics of the initial object, in accordance with some embodiments of the disclosure;

FIG. 8 is an example of a user interface that allows viewing options, in accordance with some embodiments of the disclosure;

FIG. 9 depicts examples of types of interactions with a reference object, in accordance with some embodiments of the disclosure;

FIG. 10 depicts examples of types of interactions with a reference object and the characteristics of the reference object, in accordance with some embodiments of the disclosure;

FIG. 11 is an example of a side-by-side display of an initial object and a reference object, in accordance with some embodiments of the disclosure;

FIG. 12 is an example of reference objects that carry lesser reward scores than reference objects that are directly related to the initial object, in accordance with some embodiments of the disclosure;

FIG. 13 is an example of multiple reference objects that may be used to enhance an initial object, in accordance with some embodiments of the disclosure;

FIG. 14 is an example of multiple reference objects that may be used to enhance an initial object, in accordance with some embodiments of the disclosure;

FIG. 15 is an example of a non-commercial reference object that may be used to enhance an initial object, in accordance with some embodiments of the disclosure;

FIG. 16 depicts a block diagram for a method for communications between components of an enhancing system for enhancing an initial object with a reference object for conceptualization, in accordance with some embodiments of the disclosure;

FIG. 17 is a flowchart of a method for building a reference object store, in accordance with some embodiments of the disclosure;

FIG. 18 depicts a block diagram for a method for communications between an objects datastore, an XR device, and an XR server, in accordance with some embodiments of the disclosure; and

FIG. 19 is a block diagram of scoring engine for scoring a reference object, in accordance with some embodiments of the disclosure.

### DETAILED DESCRIPTION

In accordance with some embodiments disclosed herein, some of the above-mentioned limitations are overcome by identifying an initial object, such as a virtual object displayed on an extended reality device or a real-world object viewed through a camera, obtaining one or more characteristics of the initial object, searching for a reference object that a) shares the one or more characteristics and b) is an object with which the user, or a contact of the user, has interacted with, scoring the reference object based on a plurality of scoring factors, selecting a scored reference object, and displaying it with the initial object based on a display preference or setting such that the initial object is given context based on the displayed reference object.

Generally, a virtual object is a model, graphical rendering, image (or portion thereof), or video (or portion thereof) that may be displayed by an electronic device in the following contexts: (i) in a rendered 2D or 3D virtual environment or (ii) as an overlay for a real-world, mixed reality scene, or virtual reality scene. In some instances, a virtual object may be a 3D digital object with modeled physical dimensions (e.g., include an assumed width, depth, length, etc.) that enable the 3D digital object to be placed in a 3D space of a VR or AR environment such that it appears to be an object within the environment. In some instances, the virtual object may be interactive, such that a user can touch, grab, or move the virtual object. In some instances, a virtual object may be a content item (e.g., an image or video). Depending on the embodiment, the content item may itself be a 3D digital object or a part of a 3D digital object, even when flat (e.g., an image might be assigned a fixed set of measurements relative to the scene, as well as coordinates where the user may be able to “pin” the virtual object to a particular position or location). In some embodiments, the content item may not be placed in a 3D scene. Rather, it may be displayed on a plane that is fixed relative to the user's perspective (e.g., such as that the content item appears to be displayed on a screen or a portion of a screen rather than within a 3D scene viewable via the screen).

The disclosed techniques enable the disclosed XR systems to provide context to a user when the user is viewing an initial object of interest (e.g., a real-world object or a virtual object). By providing context, the disclosed techniques can be implemented to avoid a scenario in which the user is left uninterested in the virtual object due to a lack of context (e.g., wherein the user ignores the virtual object or fails to take any subsequent actions associated with the virtual object). For example, if a virtual object is a sofa and is displayed without context, the user may ignore it or fail to take any subsequent action (e.g., analyzing it further and then buying a product depicted or represented by the virtual object). Displaying virtual objects (especially those representing products or services for sale) without context affects stores, advertisers, and other institutions that spend millions of dollars on advertising and display such virtual representations of commercial objects. Since the users may ignore or not perform any purchasing actions due to the user being unable to place the representation of the virtual object into context, there is a need for methods and systems as those provided by the embodiments herein that can conceptualize a virtual representation or a live object, such that the conceptualization places the virtual representation or a live object into context for the intended user.

In some embodiments, the systems and methods described herein receive an input of an initial object. Generally speaking, an “initial object” is a real-world object (e.g., a physical, tangible item existing in the environment external to the XR system) or a virtual object (e.g., a graphical element, such as a 3D digital object, rendered for display on an electronic display) that is displayed on an electronic display of the XR system. The initial object may exist in a real-world environment, and it may be displayed via an optical see-through (OST) display or a visual see-through (VST) display that enables the user to view the real-world environment via the display. In an embodiment, the initial object does not necessarily exist in the real-world environment. For example, it may be a virtual object with no real-world counterpart.

The initial object may be displayed on an XR device, television, mobile phone or another type of electronic device that has a display. The initial object may also be a live object that may be consumed by a user via a camera of an extended reality headset, smart glasses, or a mobile phone. Generally, a “live object” is a is a real-world object (e.g., a physical, tangible item existing in the environment external to the XR system) that may be, for example, viewable via the XR device in real-time (e.g., via VST or OST mechanisms)

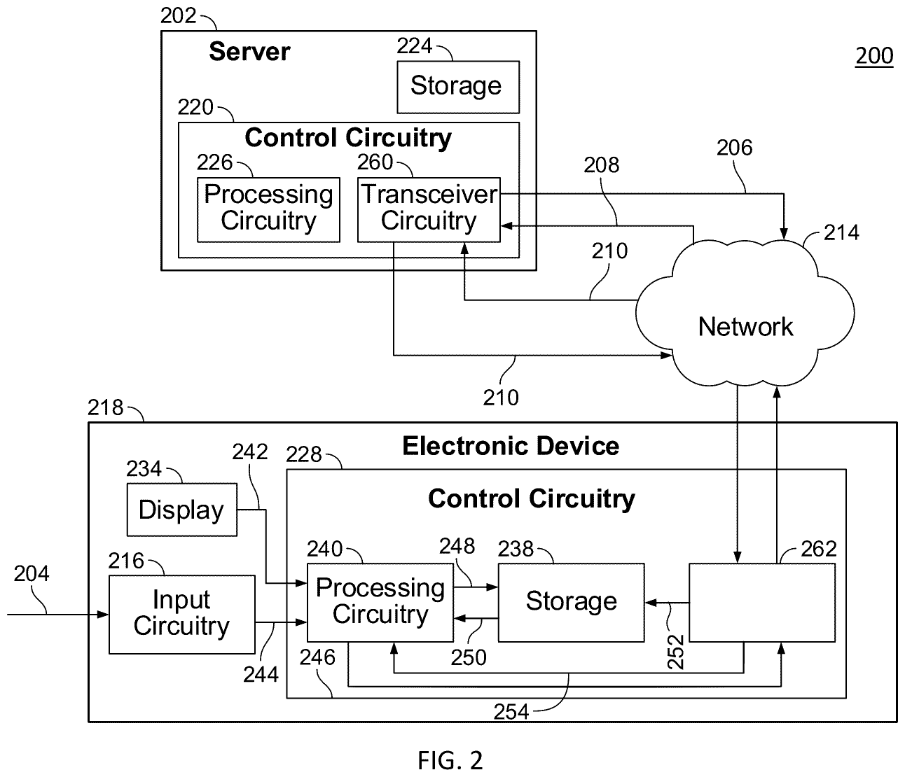

In some embodiments, control circuitry 220 and/or 228 of a system, such as the system described in FIG. 2, may obtain one or more characteristics of the initial object and use the obtained characteristics to search for a reference object.

Generally, a “reference object” is virtual object that is accessible for comparison to the initial object (e.g., by way of displaying the reference object). The reference object may be a content item or a portion of a content item, such as a depiction within an image or video of a real-world object. In some embodiments, the reference object may be a 3D digital object as previously described. The described techniques may select a reference object (e.g., based on the selected reference object having shared characteristics with an initial object and/or based on user interactions with the reference object) to provide context to a user.

In some embodiments, control circuitry may determine whether the initial object is of interest prior to obtaining the one or more characteristics of the initial object. For example, the control circuitry 220 and/or 228 may determine that the user is interested in the initial object if the user has gazed upon the initial object or interacted with the initial object or performed some activity. If the initial object has appeared and the user has not gazed upon the initial object or interacted with the initial object, then control circuitry 220 and/or 228 may determine that the user is not interested in the initial object. To illustrate, the system may determine non-interest in the following scenario. A user may be walking in Times Square. Through his HMD, he may see numerous other initial objects, but he does not pay attention to any of the initial objects (e.g., he walks right by them, he does not gaze at them for a prolonged period of time etc.). Based on his lack of attention to these initial objects falling within his field of view, the system may determine a degree of non-interest (e.g., complete disinterest, interest falling below a predetermined threshold, etc.).

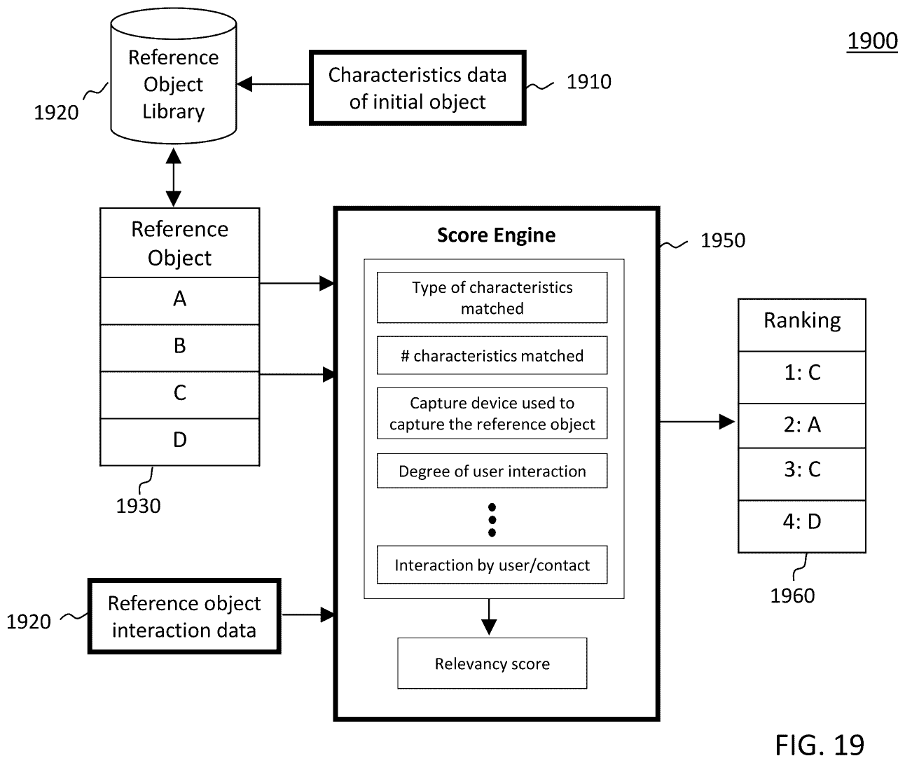

Using the obtained characteristic(s), the control circuitry 220 and/or 228 may search for a reference object that a) shares the one or more characteristics and b) is an object with which the user, or a contact of the user, has interacted with. In some embodiments, a scoring engine may be used calculate a relevancy score for the reference object, such as the scoring engine described in FIG. 19. The scoring engine may score the reference object based on plurality of categories. For example, as depicted in FIG. 19, the scoring engine may score the reference object based on the type and/or number of characteristics that are matched with the initial object, which may be referred to as similarity score. The scoring engine may also score the reference object based on a degree of determined user interaction with reference object (e.g., this may be referred to as a user interaction score). For example, a user interaction score may account for whether the reference object was captured by a device that is owned or operated by the user or if it was from a device from a contact of the user. In some embodiments the relevancy score may be combination of both the similarity score and the user interaction score. In one embodiment, the relevancy score may be a cumulative of the similarity score and the user interaction score. In an embodiment, the relevancy score may be a mean comma standard deviation or based on some other formula of the similarity score and the user interaction score. In some embodiments, the relevancy score may be solely based on either the similarity score or the user interaction score. The control circuitry 220 and/or 228 may also rank one or more reference objects identified based on the search in an order of their relevancy score.

Among other factors, one of the key factors, for determining a relevancy score is a) shared characteristics and b) interactions by the user, or a contact of the user with the reference object (referred to herein as user interaction or interaction). These factors may be used to calculate a similarity score (based on shared characteristics) and user interaction score (e.g., based on type or amount of interaction with the reference object). Since user interactions with the reference object is a key factor that is used by the control circuitry to conceptualize the initial object, such interactions come on the degree of interaction, the type of interaction are highly relevant in calculating relevancy score for the reference object. Such interactions may be determined based on input received through biomarkers, external devices, and access to a user's history. For example, a biomarker reading from a smartwatch worn by the user, which has the capability of reading heartbeats, may indicate that when interacting with a reference of object, the user's heartbeat was raised thereby indicating a high degree of interest in the reference object. In another example, a camera that is installed in the user's living room may capture a video of the user sitting on his sofa. The video (and associated metadata, if desired) may be processed by the control circuitry 220 and/or 228 to determine that the user has interacted with the reference object, which in this case is the sofa. The control circuitry 220 and/or 228 may determine that the act of capturing an image or video is, itself, the user interaction.

Once the reference object has been identified, the control circuitry 220 and/or 228 may determine a display option for displaying the reference object along with the initial object. Some of the display options may include, displaying the reference object side by side with the initial object or overlaying the reference object on an image that includes the initial object. By identifying a reference object that (i) has shared characteristics with the initial object and (ii) is one with which the user has interacted, and by displaying it along with the initial object, the control circuitry 220 and/or 228 provides context to the initial object and enables a user to better conceptualize how he or she might use or interact with the initial object. As such, the initial object is not viewed in a vacuum, but instead given contextual meaning based on the user's personal real-life experiences with a reference object that shares similarities with the initial object.

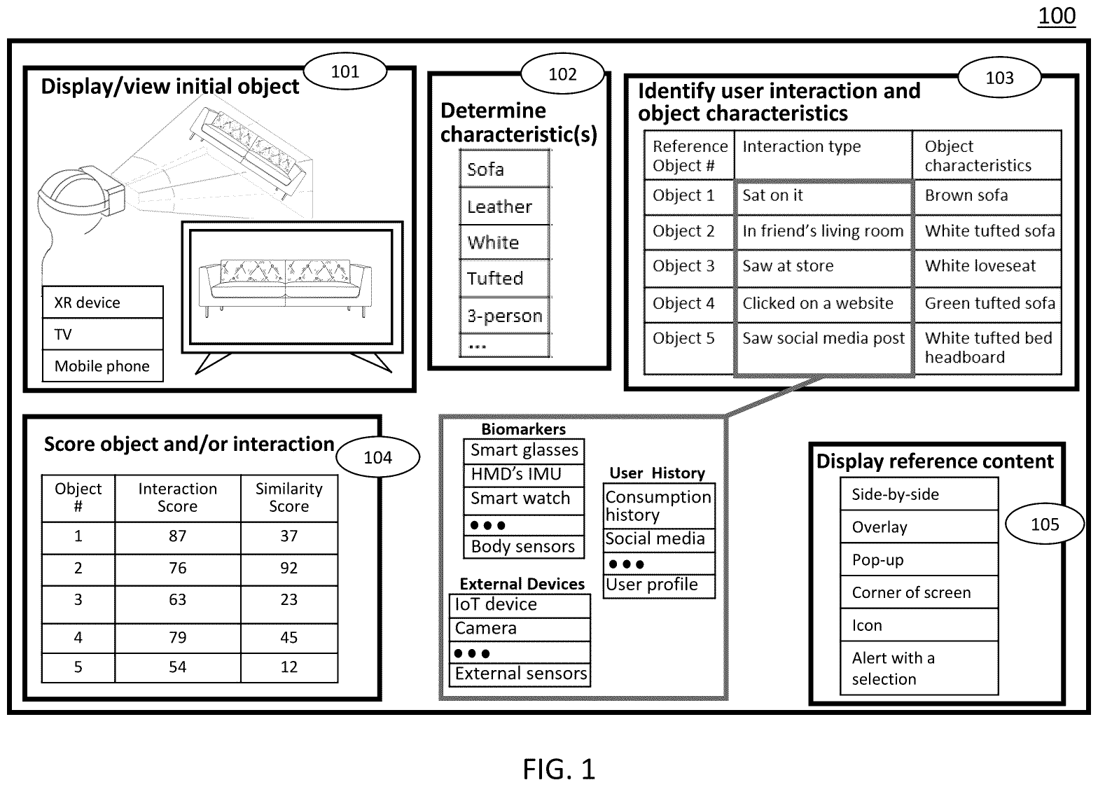

FIG. 1 is a block diagram of for a method 100 for enhancing an initial object with a reference object for user conceptualization, in accordance with some embodiments of the disclosure. As referred to herein, the phrase “enhancing an initial object with a reference object” is to be construed broadly to include displaying, via any suitable display device (e.g., including a screen), the initial object with a reference object. The initial object may be displayed with the reference object such that an activity, interaction, or engagement with the reference object is displayed, suggested, or alluded to, providing a familiar context to a user to better conceptualize the initial object. In some embodiments, conceptualizing and providing familiarity may be used to refer to similar concepts.

In some embodiments, as depicted at block 101, an initial object is displayed on a display of an electronic device. The electronic device may be a personal computer (PC), a laptop computer, a tablet computer, a WebTV box, a personal computer television (PC/TV), a PC media server, a PC media center, a handheld computer, a mobile telephone, a smartphone, an extended reality (XR) device (e.g., virtual, augment, or mixed reality device, a virtual or augmented reality headset, or a device that can perform function in the metaverse), or any other device, computing equipment, or wireless device, and/or combination of the same capable of suitably displaying an initial object on a display screen. The electronic device may also be a television set, or a display connected to set-top or DVR module.

In some embodiments, the initial object may be depicted in a virtual image, or a portion of a virtual image. In such embodiments, the XR device may be an XR headset worn by the user. The XR headset may be a device that can be worn by a user by wrapping around their head, or some portion of their head, and in some instances, it may encompass the head and the eyes of the user. In some instances, the XR headset may have a form factor similar to a typical pair of eyeglasses. The XR headset may allow the user to view virtual objects in the virtual or metaverse world. The XR headset may include an optical see-through (OST) display that is sufficiently transparent to allow the user to view real-world objects as if viewing the real-world objects through glass. In some instances, the XR headset may include a video see-through (VST) display that renders an image or video captured by one or more cameras of the XR headset. The cameras and display may be configured such that the rendered image or display gives the user the impression that he or she is looking through the display, as if looking through eyeglasses. The XR headset may be configured to display virtual objects on a VST or OST display, augmenting a scene of real-world objects with the virtual objects, for example. The XR device may display a virtual object, such as an initial object that is a sofa, smartwatch, video game, a logo of a product etc. The virtual object may be used as an initial object by the control circuitry 220 and/or 228 to perform additional analysis.

In some embodiments, the initial object may be depicted in a live image, or a portion of a live image. The live image may be displayed on the electronic device, such as the XR device. In one embodiment, the XR device may be a wearable device, such as a head-mounted display (HMD) or smart glasses with control circuitry 220 and/or 228, that allows the user to see through a transparent glass to view the real-world live input in the user's field of view. Such see-through functionality may be an optical or a video see-through functionality. In some embodiments, the electronic device may be a mobile phone having a camera and a display to intake the live feed input and display it on a display screen of the mobile device. The devices mentioned may, in some embodiments, include both a front-facing or inward-facing camera and an outward-facing camera. The front-facing or inward-facing camera may be directed at the user of the electronic device, while the outward-facing camera may capture the live images in its field of view.

In some examples, the XR device may comprise means for eye tracking, which may be used to determine the user's gaze to determine which initial objects, or images in which an initial object is a portion of the image, are being gazed upon by the user when the user is viewing a scene using the worn XR device. For example, if a user is gazing at a white tufted leather sofa with buttons, then the eye tracking may be able to determine that the gaze is focused on the notification.

In some embodiments, the initial object may be storefront in a store. In such embodiments, a user may be inside a store or looking at a store's window display from outside the store. The user may be using an XR device or a mobile phone to look at initial objects inside the store or at the window displays. For example, these initial objects may be a sofa, a toy, a phone, a piano, an ad for a service, home decoration items, or any other item or service that is for sale in the store. The initial object may also include any advertised product, service, or package, such as a vacation package, a mobile phone minutes package, a tax service ad, a medication, a health club membership etc.

In some embodiments, the initial object may be a commercially available product or a logo, advertisement, or a digital representation of a service for sale. The control circuitry 220 and/or 228 may distinguish between whether the initial object is an item or service of sale by analyzing the input of the initial object (whether it's a displayed input or a live input) or an item that is not for sale. For example, the control circuitry may cross reference the input with a store catalog that is online. The control circuitry may also determine if a price tag is visible on the initial product. The control circuitry may also perform an Internet search automatically to determine if the product is commercially available, including if it is available within a predetermined vicinity of the user, such as within 10 miles or within the same city.

In some embodiments, the initial object may be displayed on a website or a social media site. The control circuitry 220 and/or 228, in such embodiments, may determine if the products or services consumed by the user on a website or a social media site are to be used as input of an initial object that is to be analyzed further. For example, a user may have either selected an item on a shopping website, entered a search query on the shopping website, placed the item of interest that the user intends to buy in their shopping cart, selected the item but then abandoned the website or the shopping cart, hovered over the item displayed on the shopping website, or gazed at the product displayed on the shopping website. The user may have performed other actions that can be associated with the user having an interest in the initial object.

Likewise, the control circuitry 220 and/or 228, in such embodiments, may identify initial objects that are displayed on the social media platform, such as on a social media feed of the user. When such initial objects are identified on the website or a social media site, the control circuitry may determine if the user interacted with the initial object, such as the user's gaze was fixated for a predetermined period of time, or that the user selected, clicked, or hovered over the initial object for it to be considered by the control circuitry as of interest. The control circuitry may disregard other objects in the social media feed or websites that the user scrolled through without paying any attention as not of interest to the user and as such do not perform any additional analysis on such objects thereby to distinguish clutter from initial objects of interest.

At block 102, once an initial object has been identified, then the control circuitry 220 and/or 228 may determine its characteristics. For example, if the initial object is a sofa, the control circuitry may determine that its characteristics include object type (e.g., sofa, seat, furniture, article for sitting, etc.), material (e.g., leather, polyester, etc.), color(s) (e.g., white, blue and grey, etc.), feature(s) (e.g., tufted, buttoned, etc.), size (e.g., quantified by an objective linear measure, such as 10′×3′, or by intended use, such as “3-person” or “2-person”), and any other characteristics that represent the initial object, such as brand, price, location of store where it is sold etc.

At block 103, the control circuitry may query to find reference objects from one or more databases (e.g., to find reference objects relevant to the initial object). In an embodiment, the control circuitry may use one or more characteristics of the initial object as part of a search query to determine which reference objects in the databases include a shared characteristic. If the characteristics of the initial object are sofa, leather, white, tufted, a 3-person sofa, then, for example, a shared characteristic may be a reference object that is a sofa. Another shared characteristic may be a reference object what is white and tufted.

At block 103, the control circuitry 220 and/or 228 may select one or more reference objects (e.g., in response to the query) based on a degree to which a user of the electronic device has interacted with the reference object (e.g., based on whether or not a user has interacted with the reference objects). In some embodiments, the determination of whether the user of the electronic device has interacted with the reference object may be performed by the control circuitry prior to determining whether certain characteristics of the initial object are shared with the reference object. In such an embodiment, a database may store only those reference objects that have already been determined as object with which the user has interacted and only these reference objects may be considered in determining a shared characteristic with the initial object. In some embodiments, the determination of whether the user of the electronic device has interacted with the reference object may be performed by the control circuitry after determining whether certain characteristics of the initial object are shared with the reference object. In such an embodiment, a database may store only those reference objects that have shared characteristics and then analyze those reference objects to determine if they were interacted with.

Regardless of the order in which shared characteristics and interaction(s) with the reference object are determined, as depicted in block 103, shared characteristics with the initial object and their interaction types and details may be determined and stored in a table, list or in another form in a database. As depicted, in block 103, in five reference objects and their shared characteristics with the initial object and their interaction types and details are listed in the table provided.

As depicted, reference object 1 is a brown sofa. It shares a characteristic with the initial object, which is that they are both sofas. This brown sofa may have been captured via a camera or an IoT device in a room in which it is located. The camera or an IoT device may also capture an image of the use sitting on the sofa. Such capture information may be used by the control circuitry to determine that the user has interacted with the reference object.

As depicted, reference object 2 in some embodiments is a white tufted sofa. In such embodiments, reference object 2 shares multiple characteristics with the initial object, which are that they are both sofas, white, and tufted. In such embodiments, a camera, an IoT device, a camera of the XR headset, or a mobile phone camera, may have captured an image or live video of the reference object 2 (white tufted sofa) including that is located in a living room. The control circuitry 220 and/or 228 may use the data to determine that the living room is associated with a friend of the user, such as by determining the GPS location of the reference object and searching the user's contacts database to then correlate that the user's friend lives at the GPS location.

Reference object 3 in some embodiments is a white loveseat. As shown in this example, reference object 3 shares one characteristic with the initial object, which is that they are both white. In this example, the interaction by the user with reference 3 is that the user saw the white loveseat at the store. If the user was wearing an XR headset or had their mobile phone camera on, such interaction may be captured by an outward facing camera of an XR headset or a mobile phone. The control circuitry may use the data input of the white loveseat and the GPS location of the user at the time to determine that the white loveseat is at a particular store. The control circuitry may cross reference the GPS location of the user with an internet search to determine that a store is located at the GPS location. Since it's a loveseat and not a sofa, in some embodiments, the control circuitry may not consider it to be relevant (or may consider it somewhat relevant, but perhaps less relevant than a sofa). However, in some embodiments, since the loveseat may be something that may remind the user that he needs a bigger sofa for 3-person as opposed to a loveseat which can only fit one person, the control circuitry 220 and/or 228 may determine it to be relevant. Whether its relevant may also depend on the relevancy score, or aggregated relevancy score, that is calculated at block 104. For example, a relevancy score may be scaled 1-10, wherein a relevancy score of 1 indicates a complete lack of relevance and a relevancy score of 10 indicates the highest possible indication of relevance. The control circuitry may calculate a relevancy score of 8, for the reference object, with respect to the initial object, suggesting a fairly high relevance.

Reference object 4 in some embodiments is a green tufted sofa. In this example, reference object 4 shares two characteristic with the initial object, which is that they are both a sofa and they are tufted. In this example, the control circuitry 220 and/or 228 may track a user's consumption relating to website browsing, online shopping cart or basket interactions, and online purchases, to name a few. In some cases, users may add initial objects (items of sale) to their cart on an eCommerce website or phone application and then exit the website without completing a purchase. Other online interactions with reference 4 may include user hovering hover over, clicking, or selecting an initial object. The user may also gaze at reference 4 that is on a website for a duration of time. Such gaze, the direction of the gaze, and the duration of the gaze may be captured by a camera associated with a device on which the user is consuming the website content, such as an inward facing camera of a mobile phone or a camera of a laptop. Other than the examples described above, the control circuitry may determine a user's interest in an initial object, such as reference object 4, when it's on a website through other actions performed by the user. For example, if the user added the initial object displayed on the website to a Wishlist, forwarded a link to the initial object etc.

Reference object 5 in some embodiments is a white tufted headboard of a bed. In this example, reference object 5 shares two characteristic with the initial object, which are that they are both white and tufted. In some embodiments, a higher count of shared features or characteristics may result in a higher relevancy score. In some embodiments, the degree to which a characteristic is shared may affect a relevancy score. For example, a sofa and a chair may share the characteristic of each being a piece of furniture for sitting. However, because they are different types of furniture for sitting, the control circuitry may ultimately consider the chair to be not highly relevant to the sofa despite having a shared characteristic of both being for sitting. In some embodiments, the control circuitry may track a user's social media feed to determine which reference object posted by the user's contacts have similar characteristics as the initial object. The determination of shared characteristics may be used to determine a degree of similarity between the reference object and the initial object (e.g., which may be quantified by a similarity score) and/or a degree of relevancy between the reference object and the initial object (e.g., which may be quantified by a user interaction score). If desired, the control circuitry may track a user's social media feed to determine degrees of user interaction with reference objects. A camera of the laptop, mobile phone, or other electronic device used to consume the social media feed may track the user's gaze to determine if the user interacted with the reference object posted in the user's social media feed. In this example, interaction could be the user's gaze being fixated for a predetermined period of time at the social media post. It may also mean that user clicked on the post, liked or disliked the post, added a comment etc. Such data may be used by the control circuitry to determine the type of user interaction with the reference object, i.e., the social media post.

At block 104, a relevancy score is calculated based on data obtained at block 103. A scoring engine, such as the one described in FIG. 19 may be used. In some embodiments, a relevancy score is calculated based on the type and number of shared characteristics between the reference object and the initial object.

The control circuitry 220 and/or 228, with respect to number of shared characteristics, the score, also referred to herein as relevancy score, may give a high relevancy score if the number of shared characteristics between the initial and reference objects is above a predetermined number. In some embodiments, as the number of shared characteristics approaches a 100% match, a relevancy score that corresponds to the increased percentage may be given. For example, if there are 4 characteristics identified for an initial object, if the reference object shares only one characteristic, then a relevancy score that is reflective of a 25% match may be provided. Likewise, if the reference object shares two characteristics, then a relevancy score that is reflective of a 50% match may be provided, a relevancy score of 75% if three characteristics match and a relevancy score of 100% if all four characteristics are matched. Other relevancy scores and score types may also be used when scoring based on matching of shared characteristics. In some instances, the characteristics may be weighted. For example, the relevancy score calculation may be more sensitive to an “intended use” characteristic than a “color” characteristic. In some instances, the nature of a determined user interaction may affect a relevancy score more than the degree to which a set of characteristics is shared between the reference object and the initial object. For example, a brown recliner may not have a high similarity score when compared to a white couch (e.g., indicating a moderate degree to which the two share a set of characteristics). However, a photo of the brown recliner may show the user laying in the brown recliner, which may result in a high user interaction score (e.g., indicating a high degree of user interaction for the user in interest). As a result, the control circuitry 220 and/or 228 may calculate a higher relevancy score than what might be indicated by the similarity score alone.

The control circuitry 220 and/or 228 may reward a relevancy score also based on the type of characteristic matched. For example, if the initial object is a sofa, then other reference objects that are not of the same type, i.e., a sofa, chair, loveseat, or something to sit on, even if they have other matched characteristics, such as color, leather, and tufted, may be weighted, and scored lower when the key characteristic, sofa, is not matched. A key characteristic may be a characteristic that is given more weight than other characteristics when calculating similarity scores and relevancy scores. The control circuitry may consider a characteristic to be a “key characteristic” when it determines that the characteristic likely represents a significant reason for the user's interest in the initial object. Returning to the previous example, since the intended use of the initial object is sitting, the control circuitry may identify intended use (e.g., sitting in this case) it as a key characteristic. In some instances, the control circuitry may require that a reference object exhibit or possess identified key characteristics. Accordingly, the control circuitry may identify one or more key characteristics in the initial object that it desires or requires to be present in the reference object. In some embodiments, the control circuitry may analyze all the characteristics and matched characteristics and not identify any key characteristics.

In some embodiments, a relevancy score for the number of characteristics and type of characteristic may be calculated separately and, in some embodiments, one relevancy score may be allocated for the characteristic match without scoring further subcategories such as number of characteristics and type of characteristic.

At block 104, a score is calculated based on degree of user interaction with the reference object from block 103. In some embodiments, the user interaction refers to any activity, engagement, use, or consumption of the reference object by a user that is using the electronic device at block 101. The degree of user interaction depends on a plurality of factors. Some of these factors may include device used to capture the reference object, physical engagement with the reference of object, gaze related to the reference object, location of the object, object used in a message or social media post to name a few.

In some embodiments, a factor used to determine a degree of user interaction may be the device or device type used to capture the reference object, or the user or owner of the capturing device. For example, the control circuitry may reward a higher relevancy score if an image or video of the reference object was captured by the user's electronic device. This may be because if the user used their camera, mobile phone, or another device to capture the image or video of the reference object, then such a capture may be assumed to have a higher level of interest in the reference object. In some embodiments, if the capture was from a device not owned or operated by the user, a lesser relevancy score may be associated with such a capture.

In some embodiments, a factor to determine a degree of user interaction may be physical engagement with the reference of object. For example, the control circuitry 220 and/or 228 may reward a higher relevancy score if a user physically interacted with the reference object, such as by touching the reference object, holding the reference object in their hands, using the reference object in some capacity etc. If the reference object is a sofa and the user has sat on the reference object, then such physical user interaction may be associated with a higher relevancy score. If the reference object is a ball and the user played with it, then it may be associated with a higher relevancy. If the reference object is another object like a car, a laptop, a coffee maker, Eiffel tower, or any physical object and the user has interacted by standing by it, using it, touching it, etc., these user interactions would be considered to be physical user interactions.

In some embodiments, a factor to determine a degree of user interaction may be gaze related to the reference object. For example, the control circuitry may reward a higher relevancy score if the user's gaze is directed towards the reference object or if the gaze was fixated on the reference object for a predetermined period of time. In an embodiment, gaze may be determined by way of an IoT camera directed at the user. The user, in some embodiments, may be wearing a virtual headset that include an inward facing camera. The inward facing camera may detect the user's gaze or prolonged gaze at the reference object. In yet another embodiment, the user may be using their mobile phone to view a reference object. While the outward facing camera of the mobile phone may be directed at the reference object an inward facing camera may capture the user's gaze at the reference object. Other devices such as laptop, tablet, or any other device that has an inward facing camera or capability have a camera directed at the user's eyes can also be used to determine the user's gaze.

In one embodiment, a factor to determine a degree of user interaction may be location of the reference object. For example, the control circuitry 220 and/or 228 may reward a higher relevancy score if the location of the reference object is a place where the user frequently visits. For example, if the reference object is at the user's home, at the user office, at the home of the user's close family, such as the user's parents or siblings, or at a location where the control circuitry determine that the user frequently visits. Such data of where the user visits, user location, etc. may be determined, for example, based on GPS location of the user's mobile phone.

Although a few examples of factors to determine the degree of user interaction were described above, the embodiments are not so limited. Other embodiments, as described in FIG. 19 below may also be used to determine degree of user interaction and scored based on the user interaction.

In some embodiments, the user interactions may be determined based on biomarkers associated with the user. In some embodiments, user interactions may be determined based on user history or external devices directed at the user.

With respect to biomarkers, the user may be wearing a device through which biomarker data can be obtained to determine user interaction with the reference object. For example, the user may be wearing smart glasses, head mounted display (HMD), smart watch, body sensors or other devices such as medical devices (e.g., heart rate monitors). If the user is wearing smart glasses, their gaze, dilation of their eyes or excitement in their eyes (such as eyes opening wide) when they are consuming the reference object may be used to determine interaction with the reference object. For example, if the inward facing camera of the HMD detects that the user's gaze is directed at the reference object, then interaction with the reference object is determined. Likewise, if the user is wearing a heart rate monitor, and while consuming a reference object his heart rate goes up above a predetermined threshold, then the control circuitry determines that the user is interested in the reference object and the interaction is the user's consumption along with the heart rate going above the predetermined threshold.

With respect to user history, the control circuitry 220 and/or 228 may analyze a user's consumption history, social media history or internet browsing history, or user profile to inform determinations regarding user interaction with a reference object. For example, the control circuitry 220 and/or 228 may determine which reference objects the user has interacted with in the past predetermined period of time, such as in the past 1 week, 3 months, 1 year etc. For example, if the user consumption history, which may be obtained via data from execution of a machine learning algorithm, reveals that the user has clicked on an internet page that includes an image of a sofa, selected a picture in their photo library that discloses a sofa, or another record of some past user interaction, then the control circuitry may determine that the user has interacted with the reference object.

With respect to external devices, which are devices aside from the user's electronic device (e.g., the device 218 shown in FIG. 2), the control circuitry may analyze input via such external devices to determine user interaction with a reference object. For example, input from a camera that captures activity, such as a user interaction, in a room, such as a security camera, CCTV camera, and IoT camera, where a user is captured via the camera sitting on a sofa, is used to determine user interaction. Likewise, other external devices such as sensors and IoT devices, digital assistants (like Alexa™, Siri™, or Google Assistant™) may also capture user speech or other input that can be accessed by the control circuitry to determine if the user interacted with a reference object. For example, a listening feature of such digital assistants may overhear the user speech in which the user says, I used the new sofa at John's house, it was very comfortable, and such speech input may be used to determine user interaction with the reference object.

At block 104, in some embodiments (not shown), a relevancy score may be calculated, such as by a scoring engine of FIG. 19. The relevancy score may be based on both the similarity score and the user interaction score. A similarity score is a score based on the type and number of shared characteristics between the reference object and the initial object and a user interaction score is based on the nature, type, and extend of interaction with the reference object by the user or a contact of the user. For example, relevancy score for object 1 may be an average of both similarity score and user interaction score, such as 62((87+37)/2). The relevancy score may also be based on another type of calculation, such as a mean, standard deviation, or based on a formula.

In some embodiments, the control circuitry 220 and/or 228 may select a reference object based on its highest relevancy score. In some embodiments, the control circuitry may select any reference object that is above a predetermined threshold score. In some embodiments, the control circuitry may select a reference object that has the best combination of the highest relevancy score and most key characteristics. In additional embodiments, control circuitry may select the reference object that has the best combination of the highest relevancy score and one of user's favorite characteristics that may be determined with from the user's profile or based on user consumption history. Although some criteria of selection are described, the embodiments are not so limited and other selection criteria may also be used. For example, the user may define additional selection criteria that may be combined with relevancy scores, or a suggestion from an artificial intelligence (AI) engine that executes an AI algorithm may be used.

At block 105, once a reference object is selected. A display determination is made. In some embodiments, the display may include a side-by-side display of the initial object and the selected reference object on a display of the electronic device. In some embodiments, the display may be an overlay on a surface, or a portion of the display, or on the initial object and presented on the display of the electronic device. In an embodiment, the display may be a pop-up display on the electronic device. In some embodiments, the display may be at a corner of the screen of the electronic device. In some embodiments, the display may be an icon presented on the display of the electronic device. In an embodiment, the display may be an alert, selection of which, may display the reference object on the display of the electronic device.

In some embodiments, the embodiments described in blocks 101-105 allow a user to relate an identified (virtual or real) initial object to one or more reference (real-life) objects and the activities performed with the reference objects that are familiar to the user. By displaying reference objects, which are real-life objects, associated activities, and their relevant attribute values and interactions side-by-side with the initial object, the control circuitry allows a user to conceptualize the initial object in realistic terms based on the user's prior experience with the reference object.

In some embodiments, the control circuitry 220 and/or 228 performs virtual object recognition of the initial object in real-time, looks up an indexed reference object, which may be stored in a physical store, finds a match between attributes of the initial object and the reference object, and enhances the initial object by representing it with the reference object in one of the ways described in block 105. The control circuitry builds virtual reality objects to augment initial objects with reference objects, where the augmenting is based on the user's lived experiences with the reference objects. By performing such augmentation where familiar real-life object, i.e., the reference object, is displayed to the user, the control circuitry allows the user to conceptualize the initial object, which is unfamiliar to the user, to make it familiar.

As described above in blocks 102-103, attributes of the initial object may be captured to determine shared characteristics with the reference object that is familiar to the user. As such, in some embodiments, some metadata of the initial object is captured, however, there is no need to capture all of the metadata and store it ahead of time. Instead of storing and retrieving all attributes and their values (for initial objects) explicitly, in some embodiments, the control circuitry stores some attributes and values to enable comparison between an initial object and a reference object. However, values for the attributes that the user cares about may or may not be stored. If values for those attributes are not stored, the control circuitry may prompt or evoke the user to jog their memory and recall relevant facts based on their personal experiences, which is with interactions through reference objects.

An example of the above-mentioned embodiment is described next. In this example, the user may be interested in whether an identified sofa at a store, i.e., the initial object, will be comfortable to sit on with a mug of chocolate on the sofa arm (that is, the user knows what they want). Since such information may not be stored, the control circuitry 220 and/or 228 determines a closest matching (and most memorable to the user) reference object or objects (e.g., a real-life object or objects), and presents them to the user with which the user carried out a similar interaction (for example, sitting on a sofa with a mug) or saw someone else sitting with a mug in their sofa. The user is then reminded of the reference object by the control circuitry framing the reference object along with the initial object to make sense of the present experience. When the user sees the matching or similar reference object that shares some attributes of the initial object, the user applies knowledge derived from prior experience to assess whether this initial object, i.e., the current sofa they are viewing in the store, such as via their HMD or mobile phone camera, has an armrest that fit for their purposes, i.e., to sit on with a mug of chocolate.

In another example, the situation would be more subtle. The user may have no immediate concern for a specific (desirable or undesirable) feature of the initial object. When the control circuitry brings forth the reference object, it may allow the user to draw their own inference. For example, the user may realize that the way they used the reference object, they ended up damaging their clothes, such as scuffed the sleeves of their shirt at the elbows. Knowing such information, or being reminded of such information, the user may elect not to buy the initial object.

In some embodiments, the control circuitry 220 and/or 228 may receive an indication of an initial object being displayed on a display of an electronic device.

The “indication of the initial object” may be a signal received by the system that the initial object is displayed on a display of the electronic device or is being viewed via a see-through camera of the electronic device. This signal may be received by way of metadata (e.g., labeling objects included in a scene) or may be received by way of any suitable object recognition techniques (e.g., wherein image classification techniques or object detection techniques are leveraged to facilitate identifying objects in a real-world or virtual scene).

The control circuitry may determine a set of characteristics of the initial object. In some instances, the control circuitry may determine characteristics once an interest in the initial object is determined.

The “set of characteristics” may be or include size, color, dimensions, brand, genre or type of object (e.g., sofa, car, shoes etc.), and any other suitable characteristic that reflects an attribute of the object in question.

For each of a plurality of reference objects, the control circuitry may calculate a relevancy score based on (i) a degree to which the set of characteristics of the initial object is exhibited by the reference object; and (ii) a determined user interaction with the reference object.

The degree to which the set of characteristics is exhibited by the reference object may be represented by a variable configured for any suitable scale. For example, in some instances, the degree may be a binary variable indicating either that the reference object exhibits the characteristics or that it does not. If desired, the degree may be a variable having a value set to a scale of 1-100, wherein 100 indicates the characteristics are fully exhibited, wherein 0 indicates the characteristics are not at all exhibited, and wherein a 50 indicates the set of characteristics are at least partially exhibited.

The determined user interaction may be any suitable user interaction. For example, a user touching the reference object, gazing at the reference object, selecting the reference object on a computer, capturing an image of the reference object using a camera, or performing any other activity with the reference object. Determined user interactions may include the actions provided above by the user, as well as similar actions performed by a contact of the user (e.g., wherein the user is determined to have been made aware of the action). For example, the user's father may have interacted with a reference object, such as a sofa (e.g., the interaction may be the user's father sitting on the sofa). Despite the user not directly interacting with the reference object himself, because a contact of the user interacted with the reference object, this may be determined to be a user interaction. The system may determine that the user has been made aware of such a non-direct user interaction with the reference object, which may improve the interaction score of the reference object (e.g., relative to a scenario in which the user was never made aware of such an interaction). The system may make the determination based on a determination that the user's device received an image of his father sitting on the sofa, that the user consumed a social media post in which his father is sitting on the sofa, etc.

The control circuitry may select from the plurality of reference objects, a selected reference object based on a calculated relevancy score for the selected reference object. The control circuitry may display the selected reference object on the display of the electronic device.

In some embodiments, the control circuitry 220 and/or 228 may determine user interaction exists when a user captures an image of the reference object using the electronic device that is associated with the user (e.g., capturing the image may, itself, be the user interaction). In some embodiments, the control circuitry may increase a relevancy score of the selected reference object in response to determining that the image of the reference object was captured by the electronic device associated with the user. Since a user capturing an image of a reference object likely relates to a high level of interest in the reference object, the relevancy score of such an interaction is increased to show higher interest.

In some embodiments, the control circuitry may determine user interaction based on detecting that a depiction of a user of the electronic device is included in a same image as the reference object. In some embodiments, the control circuitry may determine user interaction based on detecting a gaze of a user directed at the reference object. In some embodiments, the control circuitry may determine user interaction based on detecting that the user consumes the reference object on a social media feed associated with a user.

In some embodiments, the control circuitry 220 and/or 228 may determine whether the initial object is commercially available for purchase. For example, the control circuitry 220 and/or 228 may automatically construct a search query and perform an internet search to determine if the initial object is listed for sale at any store. In some instance, the initial object may include metadata, such as its price or where it is offered for sale. If the initial object is not commercially available for purchase, the control circuitry may not obtain any characteristics. In some embodiments, regardless of the commercial availability of the initial object, the control circuitry may not obtain one of more characteristics such that a reference object with same characteristics can be identified.

In some embodiments, the control circuitry 220 and/or 228 may display supplemental information relevant to the initial object. Supplemental information may be any information regarding the reference object itself or regarding services, functions, products, price, availability, or locations associated with the reference object. This may include its weight, price, size, dimensions, or any other metadata relevant to the initial object. Supplemental information may indicate where a product or service associated with the reference object can be purchased. Supplemental information may indicate a virtual or real-world location for the reference object (e.g., indicating when a picture or video of the reference object was captured). The supplemental information may be presented as an icon or provided as an alert. In some instances, the supplemental information may be presented via text (e.g., in response to a user interacting with a graphical element, such as a dropdown button).

In some embodiments, the reference object is distinct from the initial object and in some embodiments the reference object and the initial object are a same object. For example, if the user is looking at a virtual sofa at Macys™ (the initial object in this example) and the user owns the same sofa and has interaction data with such sofa (reference object) then both initial and reference object may be the same type of object. The user may still be interested in the initial object, such as for example, he may want more of the same for another room in house, for a purchase as a gift, or may be looking to replace their old sofa of the same type with a newer one.

In some embodiments, the user interaction is an interaction with the reference object by a contact of a user of the electronic device, where the contact is a user's social media contact. In some embodiments, the user interaction is an interaction by the user themselves with the reference object.

In some embodiments, the user interaction is determined based on the reference object being stored in a photo-gallery of the electronic device associated with a user. For example, if the reference object is stored in Google Photos™ or mobile phone library based on the user taking the picture of the reference object with their mobile phone, then the control circuitry 220 and/or 228 may associate the appearance of the reference object in user's photo directory as an interaction and that the user may have been interested in the reference object to take its picture.

One example of operation using the process of FIG. 1 is described next. In this example, an initial object, such as the sofa depicted in block 101 may be displayed. Upon its display, the control circuitry may determine five characteristics of the sofa to be a) sofa, b) white, c) tufted with buttons, d) leather, and e) a 3-person sofa. These characteristics may be weighted equally of they may be weighted based on the uniqueness of the feature. For example, if the sofa had certain artwork on its handle that is by a famous artist, such a feature would be unique, and at least more unique than other characteristics such as white, tufted with buttons or leather. When such a unique feature is present, a higher weighted score may be assigned.

The control circuitry may detect that the user has interacted with three objects and analyze them further to determine their relevancy to the initial object. Based on the analysis, the control circuitry may select one of the objects as the reference object. To determine relevancy, the control circuitry may calculate the similarity score and the user interaction score for all three objects. The similarity score may be calculated based on the type and number of shared characteristics between the object and the initial object and the user interaction score may be calculated based on the degree and type of user interaction, or interaction by a contact of the user, with the object.

In this example object 1 may include 1 of the 5 characteristics, object 2 may include 2 of the 5 characteristics, and object 3 may include 3 of the 5 characteristics. For simplification and sake of explanation, if an equal weight of 1 is assigned for each characteristic, then object 1 would have a similarity score of 1 (for matching 1 characteristic with the initial object), object 2 would have a similarity score of 2 (for matching 2 characteristics with the initial object), and object 3 would have a similarity score of 3 (for matching 3 characteristics with the initial object). As mentioned earlier, if any of the characteristics are regarded as unique, then a higher weight, such as a 2, 3, or n, may be associated with it and the higher similarity score may be provided to the object that includes the unique feature.

The control circuitry may also calculate a user interaction score for each of the three objects. For simplification and sake of explanation, the following scores may be assigned to some exemplary user interactions. An interaction that is a) physical touch may be given a user interaction score of 3, b) user's gaze on the object may be given a user interaction score of 2, and c) physical touch by a contact of the user may be given a user interaction score of 1.

The user interaction with object 1 may be that the user's father sat on the sofa, which is a physical touch by a contact of the user. As such the control circuitry may provide a user interaction score of 1 for object 1.

The user interaction with object 2 may be the user gazing on the sofa with their virtual reality headset. As such the control circuitry may provide a user interaction score of 2 for object 2.

In this example the user interaction with object 3 may be the user sitting on the sofa, which is a physical touch. As such the control circuitry may provide a user interaction score of 3 for object 3.

Based on the score provided above, the relevancy score, which is a combination of similarity score and user interaction score, may be as follows:

$$Object 1 : 2 [ ( similarity score 1 ) + ( user interaction score 1 ) ]$$

$$Object 2 : 4 [ ( similarity score 2 ) + ( user interaction score 2 ) ]$$

$$Object 3 : 6 [ ( similarity score 3 ) + ( user interaction score 3 ) ]$$

As it can be seen, object 3 scored the highest relevancy score of 6. Accordingly, in some embodiments, the control circuitry may select object 3 as the reference object to be displayed along with the initial object. The display may be a side-by-side display of initial object and the selected reference object (object 3) or any other display formats described at block 105.

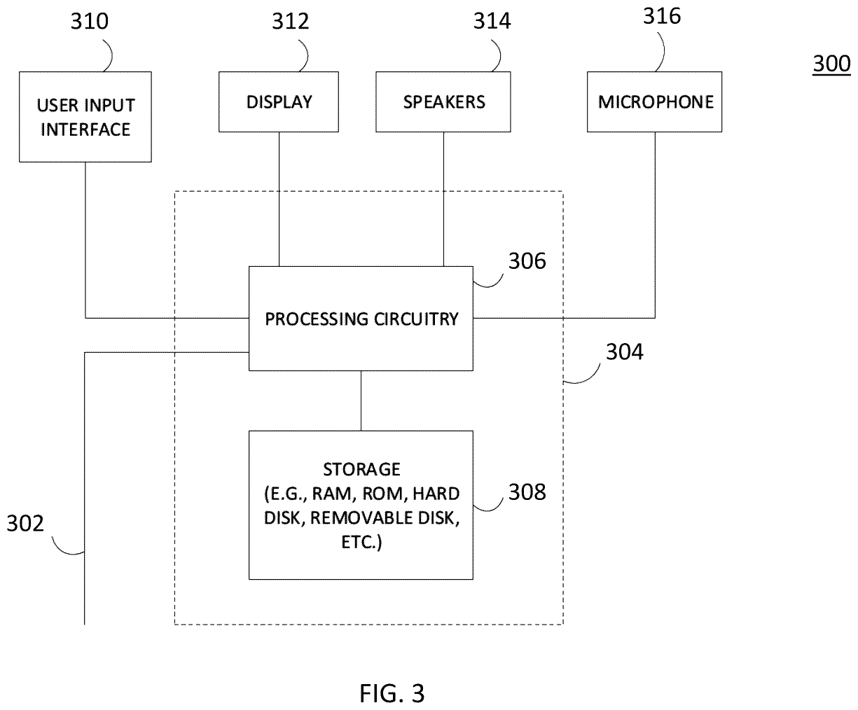

FIG. 2 is a block diagram of an exemplary system for enhancing an initial object for user conceptualization, in accordance with some embodiments of the disclosure and FIG. 3 is a block diagram of an electronic device used for receiving an input of an initial object and enhancing the initial object for user conceptualization, in accordance with some embodiments of the disclosure.

FIGS. 2 and 3 also describe example devices, systems, servers, and related hardware that may be used to implement processes, functions, and functionalities described in relation to FIGS. 1, 4, and 16-19. Further, FIGS. 2 and 3 may also be used to identify an initial object, identify an indication of display or consumption of an initial object, determine a device used for consuming the initial object, determine characteristics of the initial object, construct search queries using the determined characteristics, determine shared characteristics between the initial object and a reference object, determine whether a user, or their contact, has interacted with the reference object, receive biomarker and external device input data related to use interaction with the reference object, score the reference object based on one or more factors, calculate relevancy scores of the reference object, determine display options for displaying both the initial and reference objects and implementing and executing natural language, machine language, and artificial intelligence algorithms to determine interactions with the reference objects and conceptualization options, and performing all the steps and processes described in all the figures depicted herein.

In some embodiments, one or more parts of, or the entirety of system 200, may be configured as a system implementing various features, processes, functionalities and components of FIGS. 1, 4, and 16-19. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an Internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In some embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content, metadata, and or other types of data (e.g., they can be used to store characteristics of initial objects, list of shared characteristics between initial and reference objects, relevancy scores allocated to reference objects, interactions with the reference objects, a reference object library or data store, machine learning data, consumption histories, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to identifying an initial object, identifying an indication of display or consumption of an initial object, determining a device used for consuming the initial object, determining characteristics of the initial object, constructing search queries using the determined characteristics, determining shared characteristics between the initial object and a reference object, determining whether a user, or their contact, has interacted with the reference object, receiving biomarker and external device input data related to use interaction with the reference object, scoring the reference object based on one or more factors, calculating relevancy scores of the reference object, determining display options for displaying both the initial and reference objects and implementing and executing natural language, machine language, and artificial intelligence algorithms to determine interactions with the reference objects and conceptualization options, and performing all the steps and processes described in all the figures depicted herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an Internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to obtaining characteristics of the initial object, the control circuitry 228 may perform the steps of process described in FIGS. 1, 4, and 16-19 below and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as objects, frames, snippets or portions of videos that include the reference object, and input from devices, such as XR devices. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be a primary device, a personal computer (PC), a laptop computer, a tablet computer, a WebTV box, a personal computer television (PC/TV), a PC media server, a PC media center, a handheld computer, a mobile telephone, a smartphone, a virtual, augment, or mixed reality device, or a device that can perform function in the metaverse, or any other device, computing equipment, or wireless device, and/or combination of the same capable of suitably displaying primary content and secondary content.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core 19 processor). In some embodiments, control circuitry 220 and/or control circuitry 218 are configured to identify an initial object, identify an indication of display or consumption of an initial object, determine a device used for consuming the initial object, determine characteristics of the initial object, construct search queries using the determined characteristics, determine shared characteristics between the initial object and a reference object, determine whether a user, or their contact, has interacted with the reference object, receive biomarker and external device input data related to use interaction with the reference object, score the reference object based on one or more factors, calculate relevancy scores of the reference object, determine display options for displaying both the initial and reference objects and implementing and executing natural language, machine language, and artificial intelligence algorithms to determine interactions with the reference objects and conceptualization options, and performing all the steps and processes described in all the figures depicted herein, including executing processes described and shown in connection with FIGS. 1, 4, 16-19.

Computing device 218 receives a user input 204 at input circuitry 216. For example, computing device 218 may receive a user input like user's gaze, user's heartbeat, user's motion, or some other biomarker data or user interaction with the reference object.

User input 204 may be received from Internet browsing, virtual, augmented or mixed reality headsets, mobile data, social media platforms, SMS, digital assistants, or emails. Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4, 16-19, respectively.

FIG. 3 shows an embodiment of an electronic device 300, in accordance with one embodiment. In an embodiment, the equipment device 300 is an embodiment of the electronic device 202 of FIG. 2. Generally speaking, the electronic device 300 may perform the same functions and operations described herein as being performed by the electronic device 202 or similar devices. The equipment device 300 may receive content and data via input/output (I/O) path 302. The I/O path 302 may provide audio content (e.g., broadcast programming, on-demand programming, Internet content, content available over a local area network (LAN) or wide area network (WAN), and/or other content) and data to control circuitry 304, which includes processing circuitry 306 and a storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

The communications between two or more separate user devices to identify an initial object, identify an indication of display or consumption of an initial object, determine a device used for consuming the initial object, determine characteristics of the initial object, construct search queries using the determined characteristics, determine shared characteristics between the initial object and a reference object, determine whether a user, or their contact, has interacted with the reference object, receive biomarker and external device input data related to use interaction with the reference object, score the reference object based on one or more factors, calculate relevancy scores of the reference object, determine display options for displaying both the initial and reference objects and implementing and executing natural language, machine language, and artificial intelligence algorithms to determine interactions with the reference objects and conceptualization options, and performing all the steps and processes described in all the figures depicted herein, can be at least partially implemented using the control circuitry 304. The processes as described herein may be implemented in or supported by any suitable software, hardware, or combination thereof. They may also be implemented on user equipment, on remote servers, or across both.

In client-server-based embodiments, the control circuitry 304 may include communications circuitry suitable for allowing communications between two separate user devices to perform all functions and processes describe herein. The instructions for carrying out the above-mentioned functionality may be stored on one or more servers.

Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the Internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store characteristics of initial objects, list of shared characteristics between initial and reference objects, relevancy scores allocated to reference objects, interactions with the reference objects, a reference object library or data store, machine learning data, consumption histories, and NLP, ML, and AI algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the primary equipment device 300. The control circuitry 304 may also include digital-to-analog converter circuitry and analog-to-digital converter circuitry for converting between digital and analog signals. The tuning and encoding circuitry may be used by the primary equipment device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the primary equipment device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of primary equipment device 300 or may be a stand-alone unit. In some embodiments, the display 312 may be outputted through speaker 314.

The equipment device 300 of FIG. 3 can be implemented in system 200 of FIG. 2 as primary electronic device 202, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 300 of any other type of suitable user equipment suitable may also be used to implement ML and AI algorithms, and related functions and processes as described herein. For example, primary equipment devices such as television equipment, computer equipment, wireless user communication devices, or similar such devices may be used. Primary equipment devices may be part of a network of devices. Various network configurations of devices may be implemented and are discussed in more detail below.

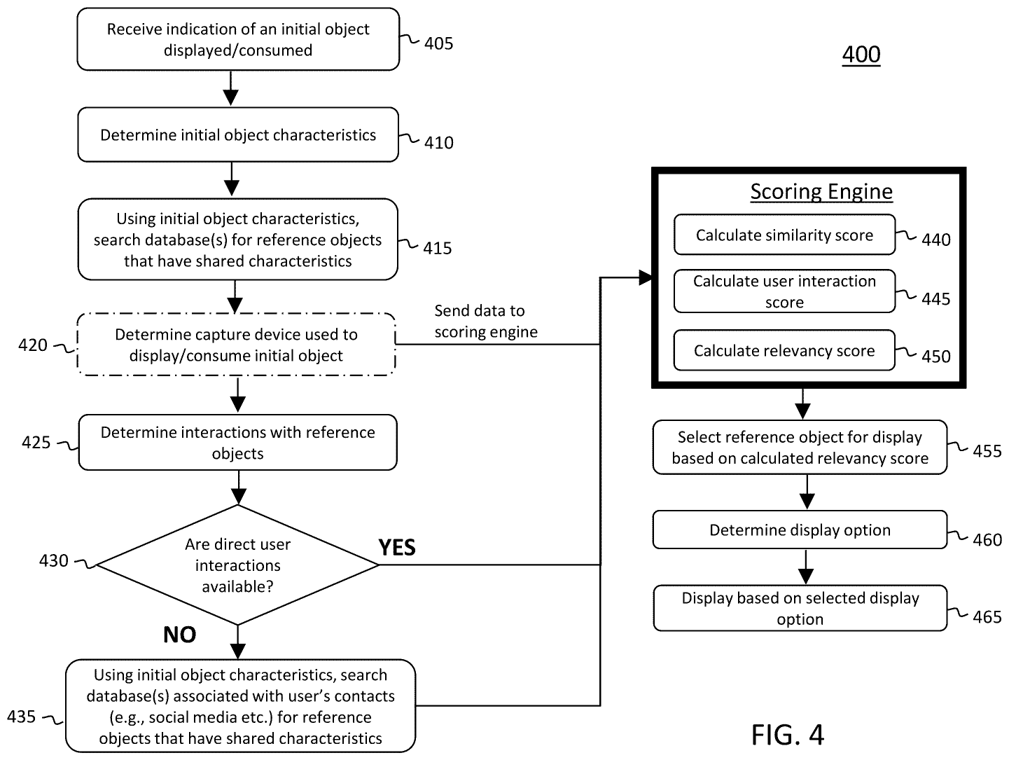

FIG. 4 is a flowchart of a method 400 for enhancing an initial object for conceptualization, in accordance with some embodiments of the disclosure. In some embodiments, the method 400 may be implemented, in whole or in part, by the systems 200 or 300 shown in FIGS. 2 and 3. Executable instructions or routines for implementing the method 400 may be stored to memory (e.g., the storages 224, 238, or 308 shown in FIGS. 2 and 3) and may be executable by one or more processors (e.g., the processing circuitries 226, 240, or 306 shown in FIGS. 2 and 3).

At block 405, an indication of an initial object being displayed on a display of an electronic device is received. Alternatively, instead of the initial object being displayed, it may be viewed via an HMD, smart glasses, or mobile phone as a live input into a camera, such as looking at a live image of a person but through the camera lens of a mobile phone. The display or live image may be consumed via a personal computer (PC), a laptop computer, a tablet computer, an XR device, in addition to being displayed or viewable via a mobile telephone, smartphone, or HMD device. It may also be consumed on television set, such as a live broadcast or a DVR program. The initial object may be a virtual image, a portion of a virtual image, a live image, or a portion of the live image, such as of a commercially available product or service for sale.

At block 405, once an initial object has been identified, then the control circuitry may determine its one or more characteristics. For example, if the initial object is a car, the control circuitry may identify car, color, shape, brand/model, and one or more essential features of the car. In some embodiments, the control circuitry may determine only a few characteristics of the initial object and not all.

At block 410, the control circuitry, using the determined one or more characteristics of the initial object, search one or more databases to find reference objects that include same characteristics. If the characteristics of the initial object are shared in the reference object, then at block 420, the control circuitry may determine if the electronic device used to capture the reference object was owned or operated by the same user who receipt an input of the initial object (either displayed on the display of their electronic device or consumed as a live image via the electronic device). Since a user capturing the reference object by themselves indicates that the user was interested in the reference object, such type of direct interaction by the user may be reported to a scoring engine such that it may allocate a higher user interaction score for such types of capture. In some embodiments, block 420 may be an optional step and may or may not be performed by the control circuitry.

At block 425, the control circuitry may determine if the reference object is an object with which a user of the electronic device has interacted. Interaction may be of many types. In one embodiment, as mentioned above, the user capturing the reference object with their own electronic device (owned or operated) is considered to an interaction and likely a higher level of interaction since the capture by own device is indicative of a higher level of interest in the reference object. Other types of interactions include website browsing and gazing upon the reference object, placing reference object in an online shopping cart or basket, purchasing the reference object, hovering over, clicking, or selecting the reference object, gazing upon the reference object for a prolonged predetermined period of time, adding the reference object to a Wishlist, forwarding the reference object in a message, or posting it on social media, such as Facebook™ or Instagram™, posting, liking, or disliking the reference object or adding comments to someone else's post that includes the reference object, are some examples of types of interaction, however, such types are not limited.

In some embodiments, determining if the reference object is an object with which a user of the electronic device has interacted, as described at block 425, is determined by the control circuitry based on any one or more of biomarker readings, user history, or data captured by external devices.

With respect to biomarker readings, such readings may be obtained by the control circuitry based on data from wearable devices, such as smart glasses, HMD, smart watch, body sensors or other devices such as medical devices (e.g., heart rate monitors). If the user is wearing smart glasses, their gaze, dilation of their eyes when they are consuming the reference object may be used to determine interaction with the reference object.

In some embodiments, the control circuitry may analyze a user's consumption history, social media history or internet browsing history, or user profile to determine which reference products the user has interacted with in the past. Data from any one or more of such histories may be indicate that the user has interacted with the reference object, such as bought it on a website, consumed it, searched it on the internet etc.

In some embodiments, data from external devices, which are devices outside of the user's electronic device, may be analyzed by the control circuitry to determine user interaction with a reference object. External devices may be positioned in a way to view the user's actions, such as capturing via a camera's FOV the actions performed by the user when the user is in its FOV.

At block 430, the control circuitry made determine whether direct user interactions are available. In other words, are the interactions with the reference object directly perform user themselves. The determination is made at block 430 that the user interactions were performed by someone else other than the user of the electronic device, i.e., another user that is a contact of the user of the electronic device who consumed the initial object, then at block 435 the control circuitry may search of the contact's databases. In some embodiments, the control circuitry may only search those contacts that are a first-degree connection to the user of the electronic device. Such first-degree contacts may include the user's immediate family, close relatives, close friends, colleagues, or anyone else the system or the user has predefined as a first degree of contact of the user. The search may be similar to the search performed at blocs 415 and 425 where the control circuitry may determine whether a reference object in a contacts database includes shared characteristics with the initial object and whether the contact of the user has interacted with the reference object.

Blocks 440-450 may receive inputs from blocks 430 and 435 and use the input to determine a relevancy score for the reference object. The relevancy score may determine the degree or level of relevancy of the reference object to the initial object. As such, whether the reference object is relevant may depend on the relevancy score, which includes both a similarity score and the user interaction score calculated by the scoring engine.

In some embodiments, a similarity score may be calculated at block 440 for the reference object. This similarity score may be calculated based on the type and number of shared characteristics between the reference object and the initial object. In some embodiments, the control circuitry may reward a similarity score based on the number of shared characteristics between the initial and reference objects. In some embodiments, the control circuitry may reward a similarity score based on the type of characteristic matched. For example, if the characteristic is an essential characteristic or a characteristic that defines the object rather than a characteristic that applies to many other objects. For example, essential, defining, or specific, or key characteristics of sofa is sofa, design, brand and for a car is its model, shape etc. Characteristics such as color that can apply to other objects that are not within the same category of sofa or cars may also be scored but not at a higher score as characteristics that are essential, defining, specific, or key characteristics of the object.

In some embodiments, an interaction score may be calculated at block 445 for the reference object. Such score may be based on degree of interaction with the reference object. In some embodiments, the interaction refers to any activity, engagement, use, or consumption of the reference object by a user that is using the electronic device. The degree of interaction depends on a plurality of factors. Some of these factors may include device used to capture the reference object, physical engagement with the reference of object, gaze related to the reference object, location of the object, object used in a message or social media post to name a few.

In some embodiments, the factor to determine degree of interaction may be based on the device used to capture the reference object. In this embodiment, the control circuitry may reward a higher relevancy score if an image or video of the reference object was captured by the user's electronic device that from someone else's device.

In some embodiments, the degree of interaction may be based on level of physical engagement with the reference object. The control circuitry may reward a higher relevancy score if a user physical interacted with the reference object, such as by touching the reference object, holding the reference object in their hands, using the reference object in some capacity etc.

In some embodiments, interaction may be based on gaze of the user towards the reference object. In such embodiments, an IoT camera may be directed at the user to determine the user's gaze. The user, in some embodiments, may be wearing a virtual headset that include an inward facing camera. The inward facing camera may detect the user's gaze or prolonged gaze at the reference object. In yet another embodiment, the user may be using their mobile phone to view a reference object. While the outward facing camera of the mobile phone may be directed at the reference object an inward facing camera may capture the user's gaze at the reference object.

In one embodiment, the factor to determine degree of interaction may be location of the object. In such embodiments, the control circuitry may reward a higher relevancy score if the location of the reference object is a place where the user frequently visits. For example, if the reference object is at the user's home, at the user office, at the home of the user's close family, such as the user's parents or siblings, or at a location where the control circuitry determine that the user frequently visits. Such data of where the user visits, user location, etc. may be determined, for example, based on GPS location of the user's mobile phone.

At block 450, a relevancy score that is an aggregate of blocks 440 and 445 may be calculated. The relevancy score may be based on both the similarity score and the user interaction score. It may be an average, a mean, standard deviation, or based on another predetermined formula.

Once the score is calculated, the control circuitry may select a reference object based on its highest relevancy score. Other selections may include selecting on the basis of score above a predetermined threshold, best combination of the highest relevancy score and most key characteristics in the reference object, best combination of the highest relevancy score and one of user's favorite characteristics that may be determined with from the user's profile etc.

At block 460, once a reference object is selected, a display option is determined. In some embodiments, the display may include a side-by-side display of the initial object and the selected reference object on a display of the electronic device. In another embodiment, the display may be an overlay on a surface, or a portion of the display, or on the initial object and presented on the display of the electronic device. In yet another embodiment, the display may be a pop-up display on the electronic device. In some embodiments, the display may be at a corner of the screen of the electronic device. In yet other embodiment, the display may be an icon presented on the display of the electronic device. In another embodiment, the display may be an alert, selection of which, may display the reference object on the display of the electronic device.

At block 465, the control circuitry may display the initial and reference object in a manner determined at block 465.

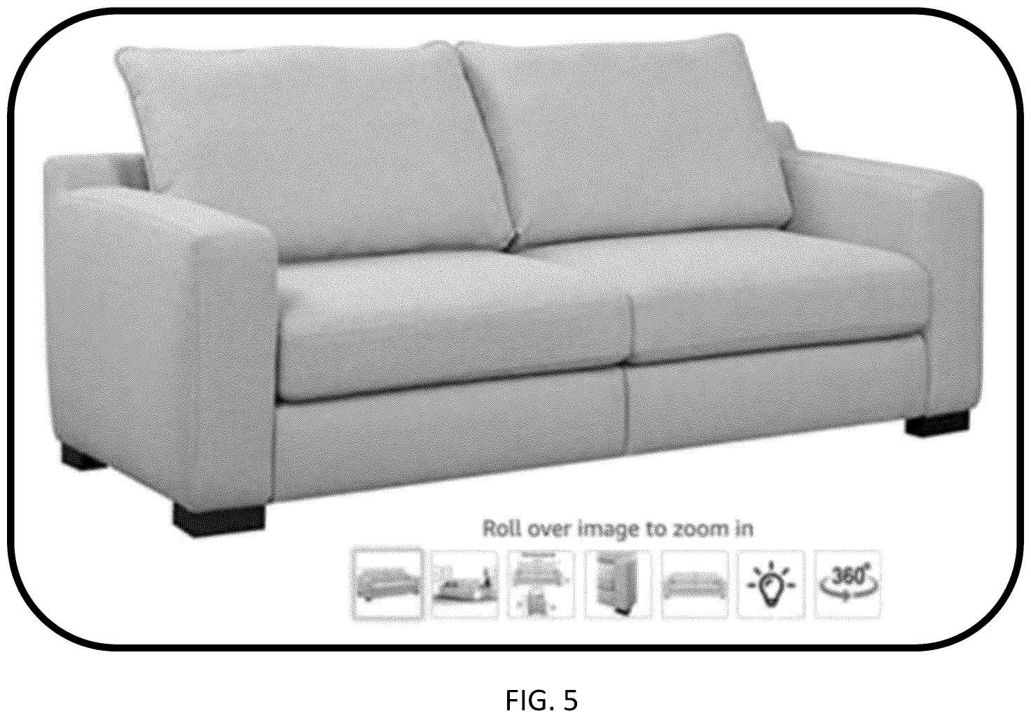

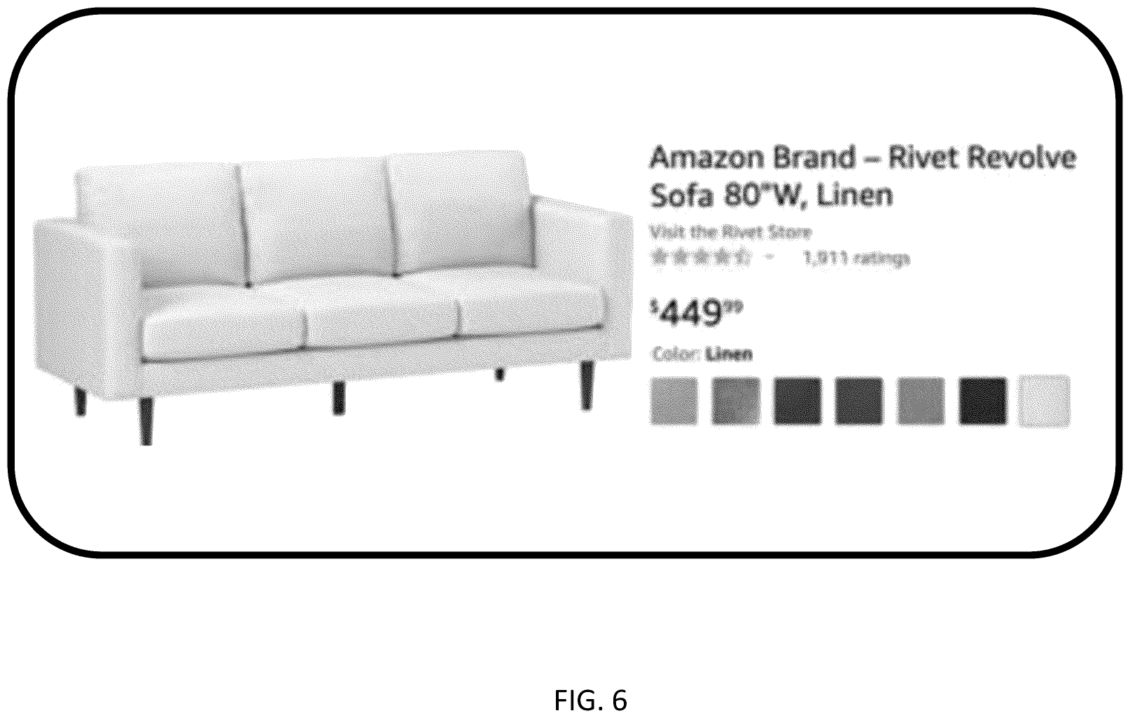

FIGS. 5-12 are examples of a reference object used to enhance an initial object, in accordance with some embodiments of the disclosure. FIGS. 5 and 6 are different types of sofas that are from different brands, e.g., FIG. 5 may be a Serta™ sofa and FIG. 6 may be an Amazon™ brand sofa.

In an embodiment, the methods and processes described in FIGS. 5-12 may be implemented, in whole or in part, by the systems 200 or 300 shown in FIGS. 2 and 3. Executable instructions or routines for implementing the method 500 may be stored to memory (e.g., the storages 224, 238, or 308 shown in FIGS. 2 and 3) and may be executable by one or more processors (e.g., the processing circuitry 226, 240, or 306 shown in FIGS. 2 and 3).

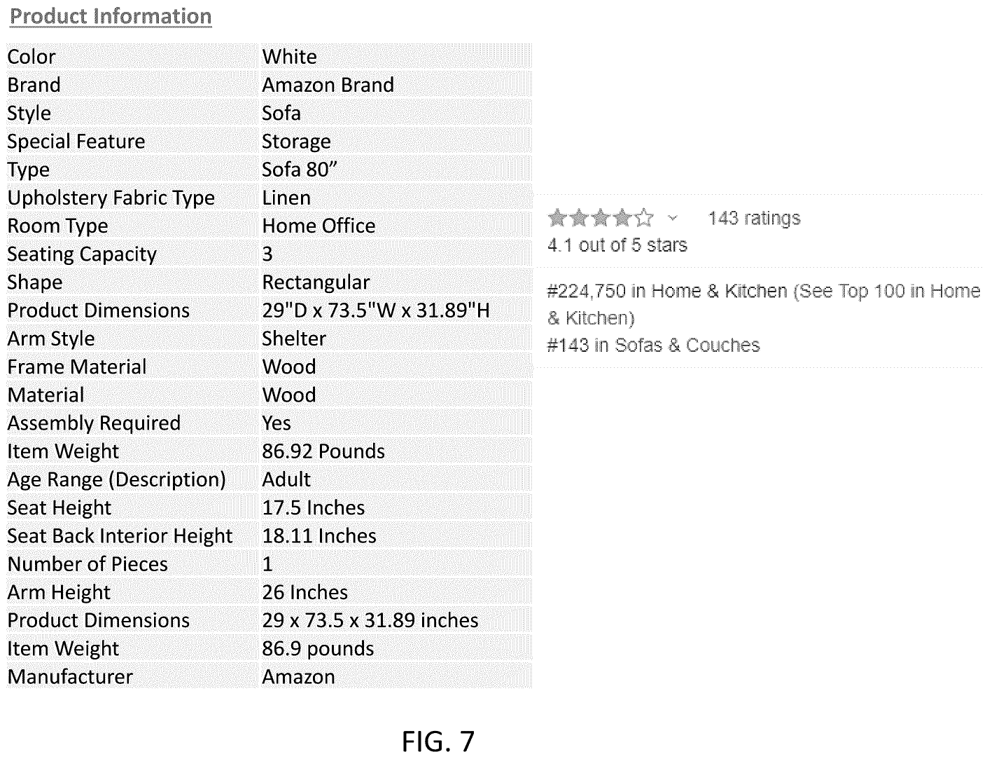

In this example, John may have moved to a new apartment in Brooklyn, New York and is looking to buy a sofa that can fit in his smaller apartment. In one embodiment, John may use an XR device that is running an AR application to visualize how a sofa would look in his room. The control circuitry may also receive product details of both the Serta™ and Amazon™ Brand sofas. The product details may include weight, height, fabric type, dimensions and other information, such as information depicted in FIG. 7.

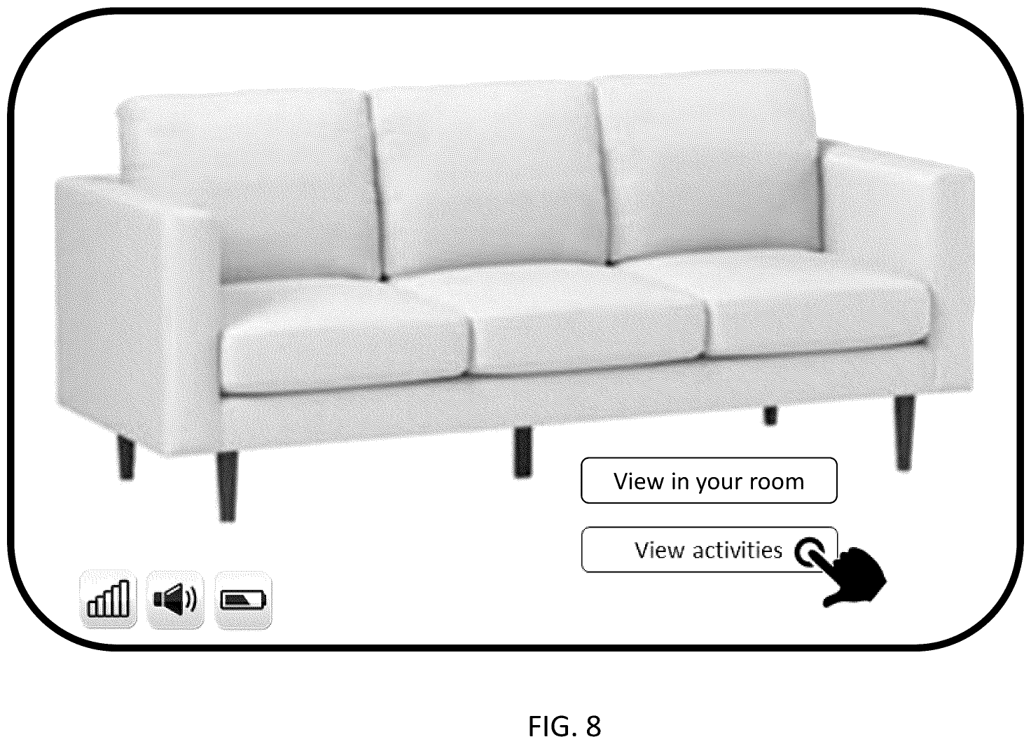

The control circuitry, in one embodiment, may use one or more of the product details as characteristics of the initial objects (i.e., Serta™ and Amazon™ sofas). In some embodiments, the control circuitry may search for a reference object using one or more characteristics of the initial objects to find reference objects that share same characteristics. In some embodiments, the user, such as John, may speak a command to ask for personal activities (on reference objects) for the sofa or he may select a button and see activities associated (with reference objects) as depicted in FIG. 8. In some embodiments, FIG. 8 may be a user interface (UI) displayed on a display of the electronic device used by the user. The UI may allow the user to select options for viewing the sofa in their room or obtaining reference objects based on selected characteristics. The UI may also allow provide the user with a list of characteristics from which the user can select a characteristic that is to be included in a search for a reference object. The UI may also allow the user to rank or prioritize the characteristics.

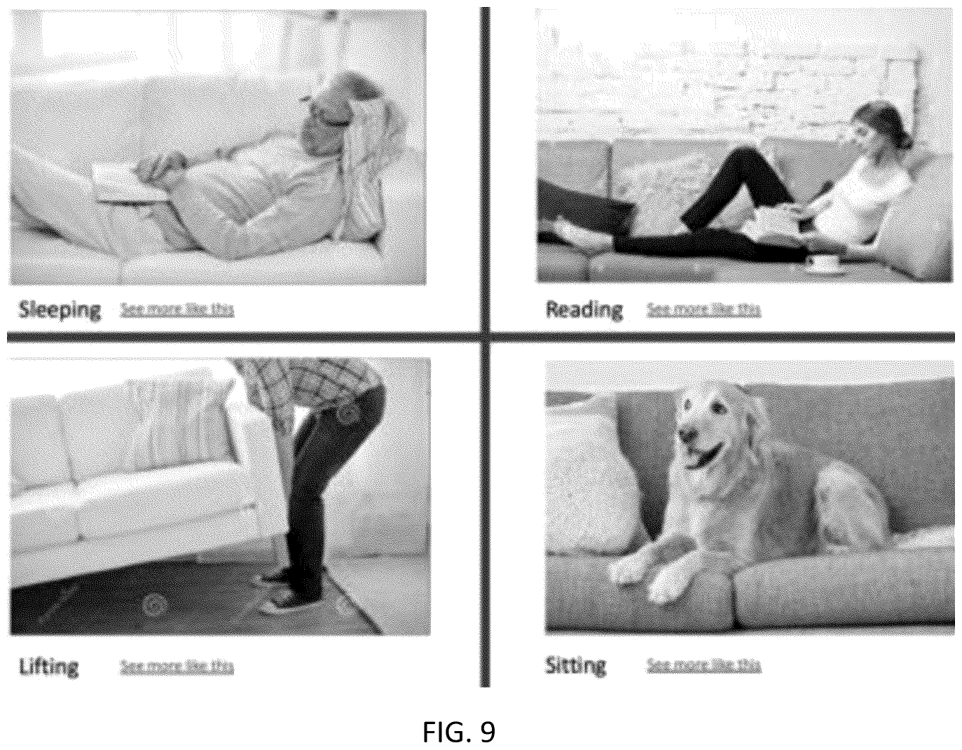

In some embodiments, the control circuitry may have scanned and stored information about John's prior activities. The control circuitry may list reference object and John's interactions with the reference objects and display them to John. In some embodiments, the control circuitry may use interactions to narrow down a list of reference object such that only those reference objects that both share characteristics and with whom John has interacted be used as a reference object for enhancing the initial object. An example of such interactions with a Sofa are depicted in FIG. 9.

Display of such interactions allows a user like John to be reminded of relatable scenarios in which an unrelatable or not so familiar initial object is given context based on things familiar to the user. In one example, as depicted in FIG. 9, the reference object may remind John that his dad visits every other month or so and has the habit of falling asleep on the sofa while reading. It may also remind him that his sister likes to put her feet up and read, eat, and work on the sofa. Further, that his dog likes to hangout on the sofa. As such John is reminded that the sofa he will purchase, such as the initial object, should be able to accommodate the regular activities and interactions that happen at his home with the reference object, his current sofa.

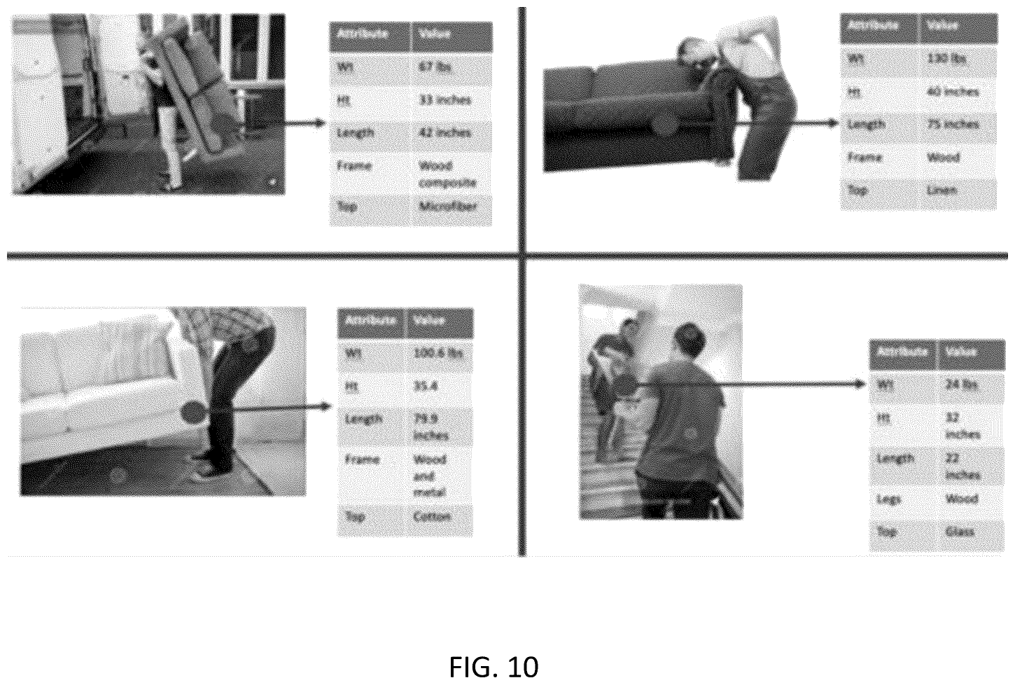

Likewise, John may also be reminded, based on the reference object's image, that John that he needs to check that he can lift the sofa with just one other person and take it up the stairs as depicted in FIG. 10 As such, knowing that he lives upstairs and that he will need to carry the sofa via the stairs to his apartment, John is reminded to check the size and weight to determine if such a lifting and carrying upstairs task is achievable.

There may be several mechanisms for John to ask for reference objects that have the characteristics that are important to him. For example, John could use speech to ask if he will be able to lift the sofa, he could gesture towards the sofa in a manner that indicates that he is trying to lift it. Recognizing such speech or behavior, input of which may be received by a microphone of the HMD or a camera feed of the HMD or an external camera in the room where John is located, the control circuitry may select reference objects that remind John of him lifting objects. When such an input is received, it may be matched against preprogrammed speech or behavior, or analyzed by an AI engine running an AI algorithm to determine what John wants, i.e., reference objects that remind him of lifting. The control circuitry may consider lifting as a key characteristic in a reference object and accordingly select reference objects that remind John of him lifting objects similar to the initial object (sofa), whose weight is close to the weight of the sofa, and which potentially have other attributes in common with the sofa. For example, as depicted in FIG. 10, a reference object selected may show a green sofa that his cousin is lifting, a loveseat that his friend Bradley is lifting on his back, and John himself climbing up the stairs with his prior couch. Such reference objects and interaction may be captured by cameras that are in a room, staircase, or by an HMD if one was worn.

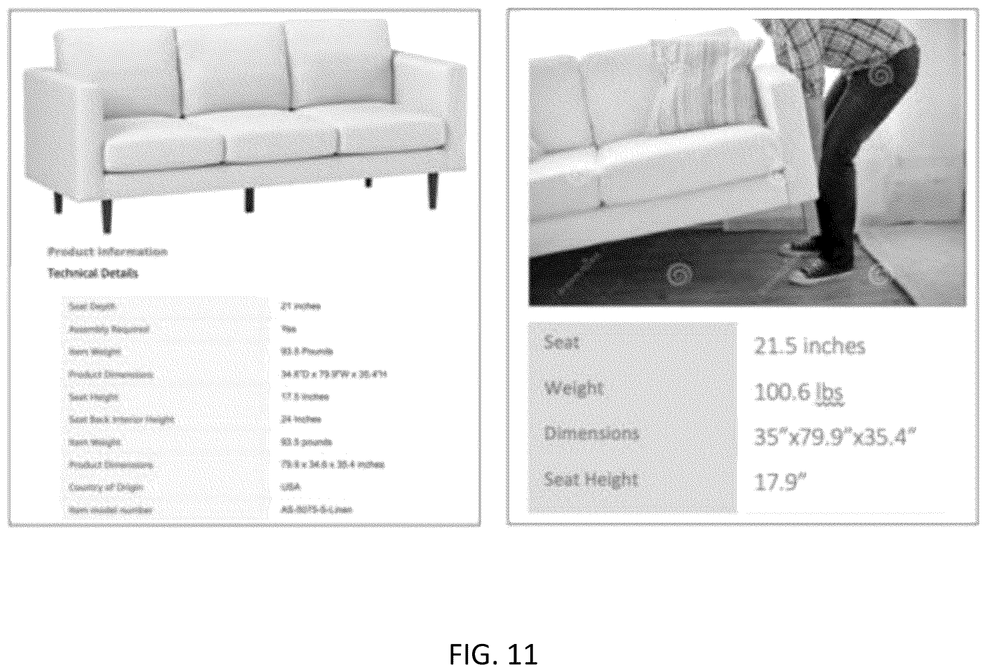

Based on the reference object selected and displayed, John may be able to conceptualize a comparison of the best match from the list of initial objects. For example, each initial object and reference object may be displayed to John as a side-by-side display depicted in FIG. 11. Having such a display of an initial object and the reference object may allow easy comparison for which is a better initial object to buy.

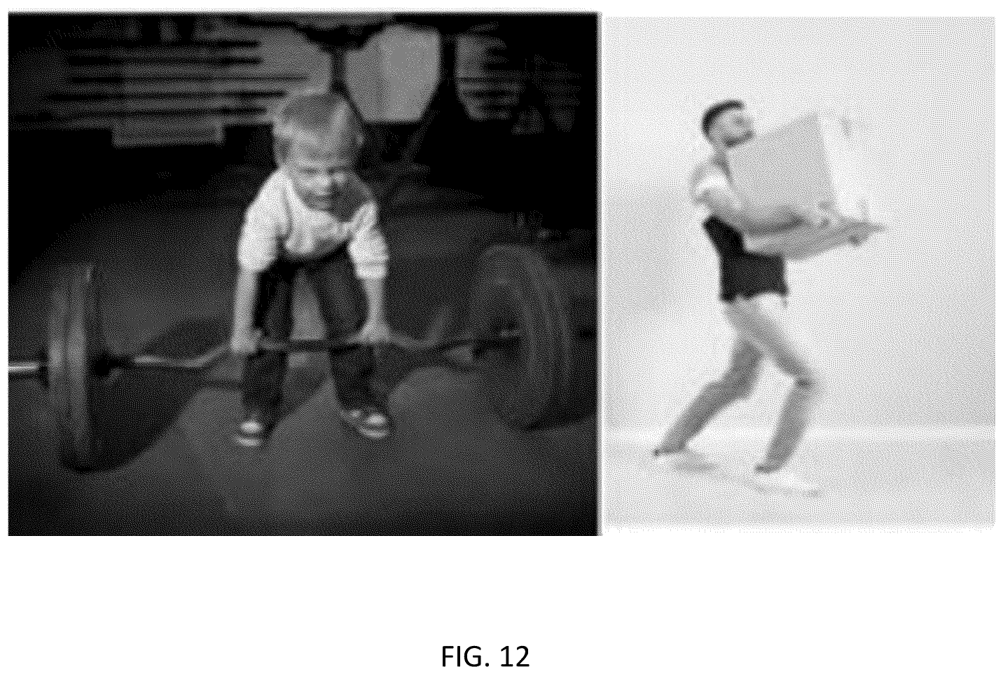

As depicted in FIG. 12, other reference objects that may have been found when searched for a characteristic of lifting may include lifting a box and lifting exercise weights. The scoring of items such items may be lower than a reference object that includes a sofa. If a reference object shows lifting of a table, since lifting a table is similar to lifting a sofa, it is presented to the user but with score higher than box or exercise weights but lower than a score for a reference object with a sofa.

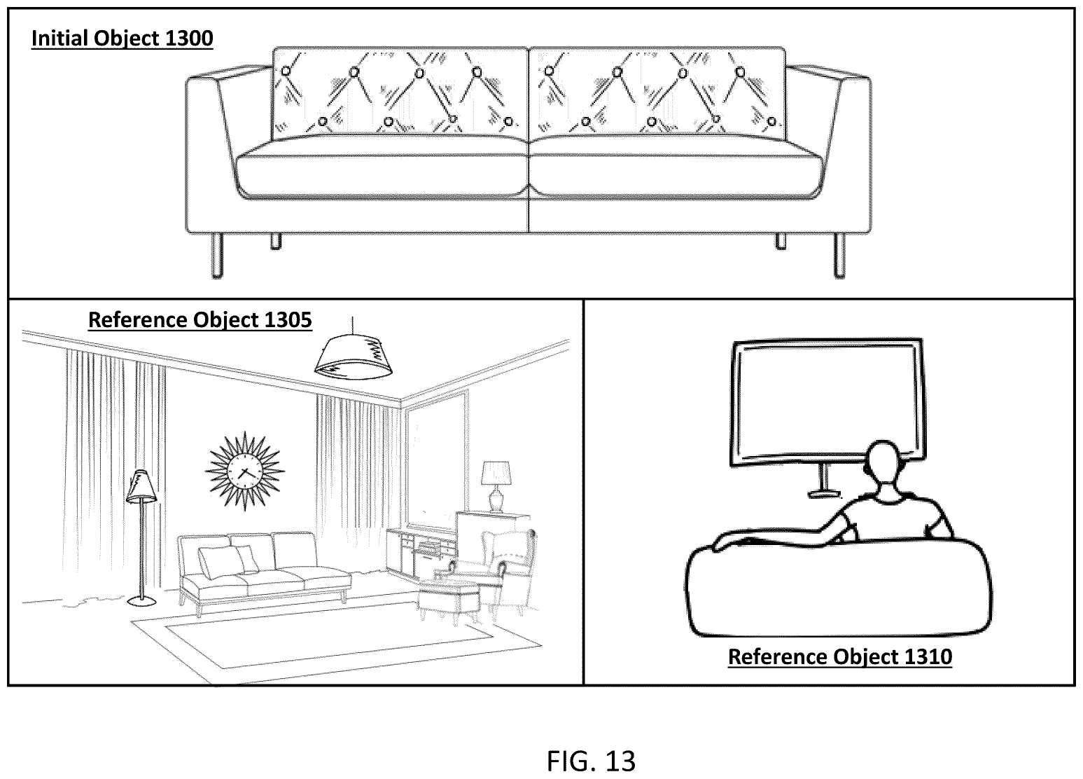

FIGS. 13-15 are examples of reference objects that may be used for the displayed initial objects. Selection of the reference objects, such as reference objects 1305, 1310, 1405, 1410, and 1510 may be made following the processes described in FIGS. 1, 4, 16-19.

FIG. 13 is an example of a reference object 1305 that might be displayed by a system (e.g., the system 200 shown in FIG. 2) to enhance an initial object 1300 that is displayed or viewable via the system, in accordance with some embodiments of the disclosure. In an embodiment, an initial object, which is a white tufted leather sofa having a pattern of buttons 1300 is depicted. Following the processes described in FIGS. 1 and 4 the control circuitry may determine that two reference objects are relevant to the initial object. In one embodiment, reference object 1305 may be a sofa in an image of a living room in the user's friend's house. The user's friend may have posted the picture of his living room on a social media website which appeared in the user's feed.

In another embodiment, reference object 1310 may be displayed by a system (e.g., the system 200 shown in FIG. 2) to enhance an initial object 1300 that is displayed or viewable via the system. In this embodiment, reference object 1310 may be a sofa with which the user has interacted by sitting on it and watching TV in his own living room. Comparing the two reference objects 1305 and 1310, the control circuitry in one embodiment may give a higher relevancy score to the sofa in the user's living room over the sofa that appeared in the user's social media feed. This is because the frequency and the type of interaction with the sofa in the user's living room would have a higher familiarity to the user as opposed to the sofa that appeared in the user's social media feed that the user consumed via having gazed upon the social media post.

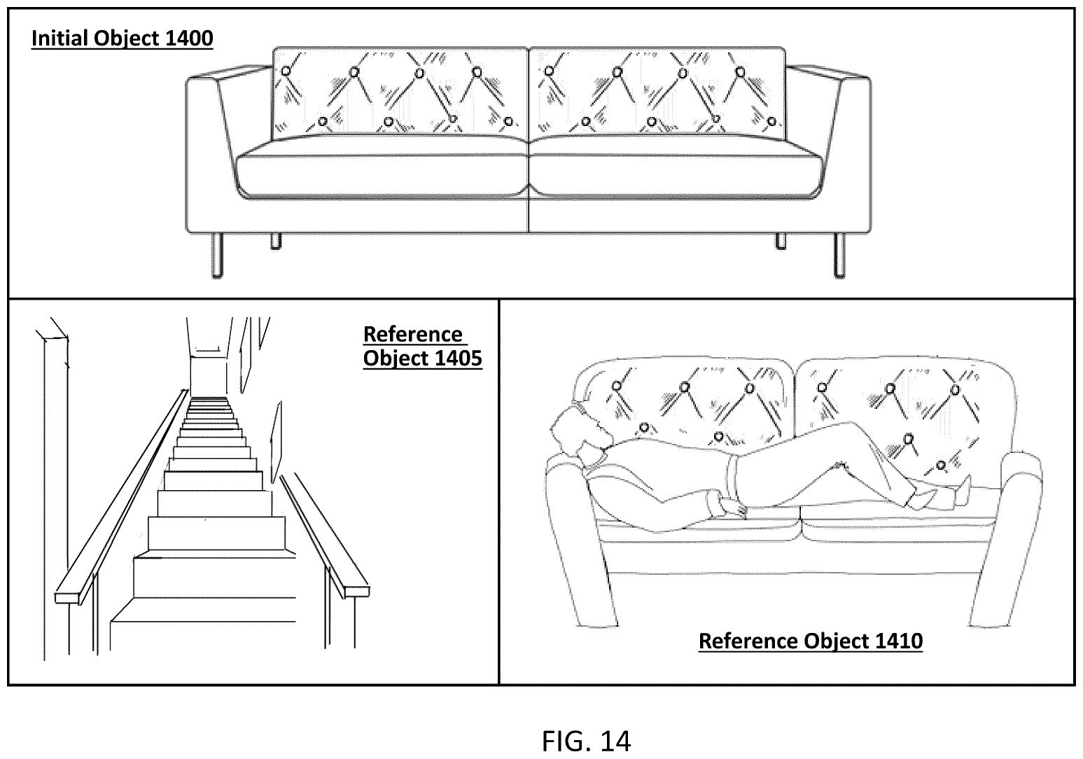

FIG. 14 is another example of a reference object Reference object 1405 may be displayed by a system (e.g., the system 200 shown in FIG. 2) to enhance an initial object 1400 that is displayed or viewable via the system, in accordance with some embodiments of the disclosure. In such embodiments, an initial object, which is a white tufted leather sofa having a pattern of buttons 1400 is depicted. Following the processes described in FIGS. 1 and 4 the control circuitry may determine that two reference objects are relevant to the initial object. In one embodiment, reference object 1405 may be a staircase that is in the user's apartment building which leads from the street level to the user's apartment on the 2nd floor. The image may have been captured by the user's camera, HMD, or mobile phone while the user walks up and down the staircase on a regular basis to get to his apartment. An AI engine may be used to process the captured image which is a sofa. The AI engine running an AI algorithm may determine that if the sofa 1400 that was received as an initial object is purchased by the user, the user needs to be reminded that the sofa will have to be carried upstairs to the second floor where the user lives. As such, the AI engine may determine that the staircase, reference object 1405, is highly relevant to the initial object because using the reference object as a reminder would allow the user to determine whether the sofa's size and weight is appropriate for carrying up to the second floor.

In another embodiment, the control circuitry may determine that reference object 1410 is relevant to initial object 1400 since both are leather sofas and have a pattern of buttons. Accordingly, the control circuit may retrieve the reference object 1410, such as from a storage of reference object with which the user has interacted and display the image of the user lying down on the reference object along with the initial object. Having the initial object and reference object displayed side-by-side, the user may determine whether the initial object is long enough for his usual use, which is lying down on the sofa and using the armrest to put his head.

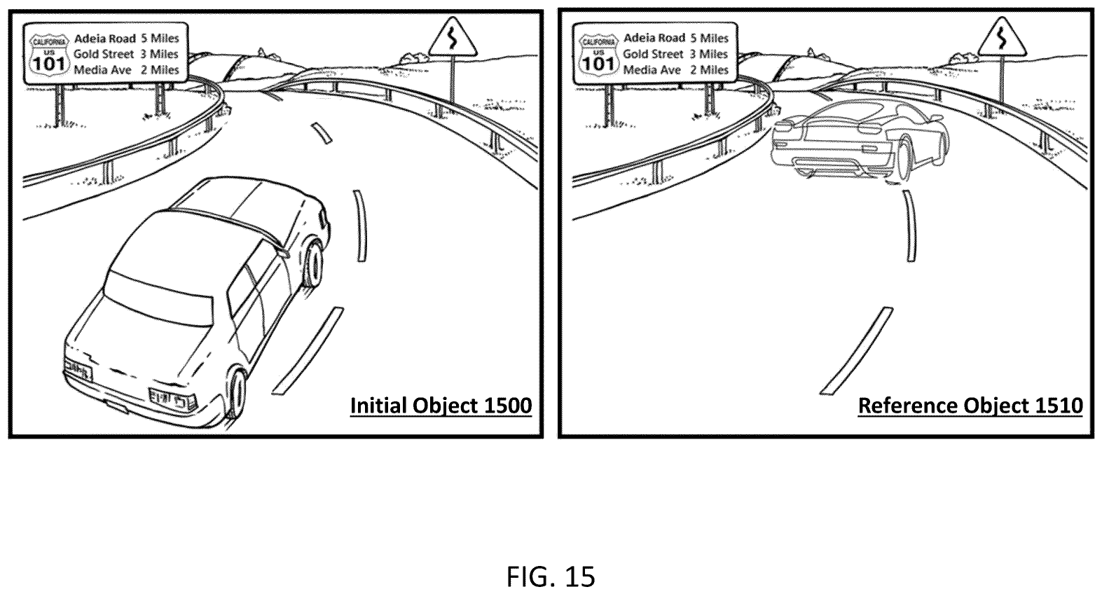

FIG. 15 is an example of using a reference object 1510 from a contact of a user to enhance an initial object, in accordance with some embodiments of the disclosure. Reference object 1510 may be displayed by a system (e.g., the system 200 shown in FIG. 2) to enhance an initial object 1500 that is displayed or viewable via the system, in accordance with some embodiments of the disclosure. In the depicted example, the initial object is curve on the US 101 highway in the direction that leads to Adeia road. Although other initial objects described in the embodiments above, such as in FIGS. 5, 6, 13, and 14, are commercial products or services for sale, in some embodiments, the initial object may be an object, a scene, or image of a location that is not commercially available for sale. For example, such objects may include road, tree, image of a space, such as the Eiffel tower, a park etc.

Staying with the depicted example, the initial object is captured by Robert's (user) car camera. Robert may be driving on the US 101 highway in the direction that leads to Adeia road. The system associated with Robert's car may receive an initial object, i.e., a curve on the US 101 highway in the direction that leads to Adeia road, via the car's forward-facing camera. The system may search for reference objects that share the same characteristics and find a reference object of the same curve on the US 101 highway in the direction that leads to Adeia road captured by Robert's father. In this scenario, previously on the same day, the father's car having a camera may record all road conditions, such as the curve on the US 101 highway in the direction that leads to Adeia road. The father may be driving along US 101 highway and when he approaches the curve, his car may encounter a road condition, such as ice on the road, water on the road, damaged road, such as potholes etc. The father's car, in one scenario, may encounter thin ice and slip on the curve. Since the automobile's forward facing captures a video recording of the road while the car is driving, having encountered the slippage, the system associated with the father's car may identify a portion/clip of the recording that is associate with the curve and the slippage and mark it as such.

When Robert's car approaches the same curve on the US 101 highway in the direction that leads to Adeia road, then control circuitry finding shared characteristics with the portion/clip captured by the father's car camera may display it to the son as a reference object along with the initial object, i.e., the curve on the road. The reference object along may provide context to the initial object and allow the son to conceptualize that the road ahead has a road condition that can cause slippage of the car and accordingly the son may make adjustments to his driving, such as slow its speed, to accommodate for the road condition.

Although the example is specific to a certain relationship and the road, the embodiments are not so limited. Other road conditions encountered by contacts of the user, such as road conditions with which the contacts have interacted, and which share characteristics with the user's initial object are also contemplated. Outside of road conditions, events such as concerts, traffic, anything else that shares characteristics and include interaction by a contact of the user are also contemplated. For example, if a contact encounters dark lighting at night on a street and the user is subsequently walking on the same street, the reference of the dark street approaching may be provided to the user such that the user may take caution and take another street to avoid anything bad happening on the dark street, such as getting mugged etc.

In another example, if a contact of the user is on a hike and encounters some shady areas where some illegal activity is occurring, and subsequently the user is on a hike that leads to the same area, the reference of the hike where illegal activity was occurring may be provided to the user such that the user may take caution and take another route on their hike.

In yet another example, if a contact of the user is parking their car in a lot and the parking lot is full, and subsequently the user is driving to the same event where the contact parked and is approaching the parking lot, the reference of the full parking lot may be provided to the user such that the user may look for parking elsewhere.

In another example, if a contact of the user is at a movie theatre, game, or a concert, and the line to get tickets is very long, and subsequently the user is enroute to the same event as the contact, the reference of the long line may be provided to the user such that the user may determine other alternatives, such as buy the tickets online, go to a different theatre etc.

In another example, if a contact of the user is buying a turkey for thanksgiving at store 1, and subsequently the user is enroute to another store, store 2, to buy a turkey for thanksgiving, the reference of the price of turkey from store 1 may be provided to the user such that the user may determine whether to buy the turkey from store 1 or sore 2 thereby allowing them to perform price comparison.

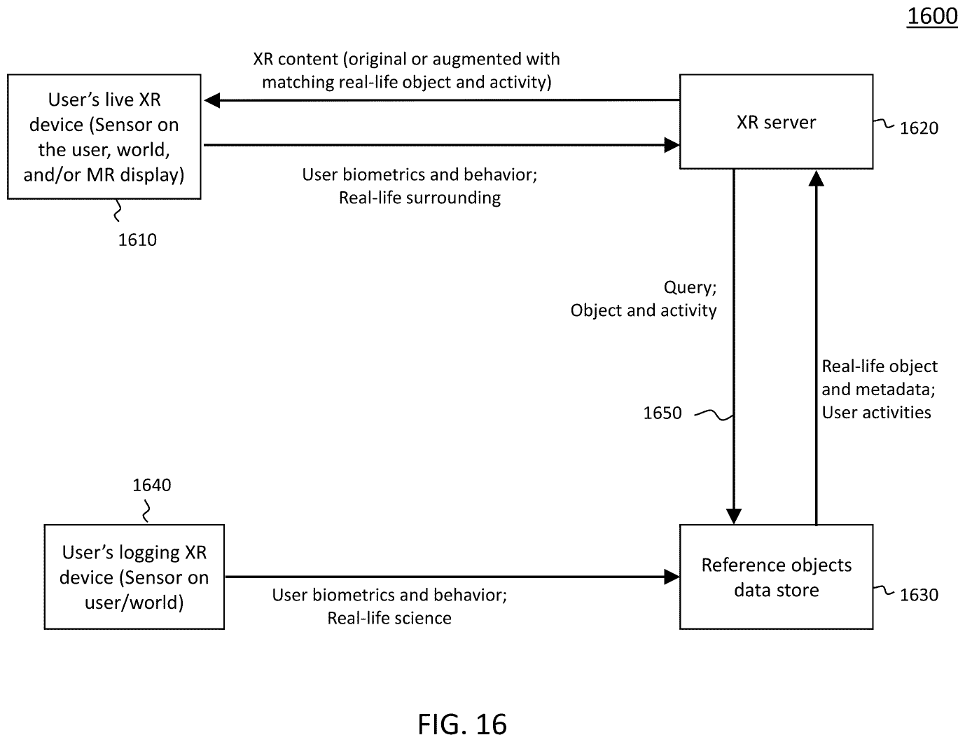

FIG. 16 depicts a block diagram for a method 1600 for communications between components of an enhancing system for enhancing an initial object with a reference object for conceptualization, in accordance with some embodiments of the disclosure. The method 1600 shown in FIG. 16 may be implemented to use reference objects for enhancing initial objects, such as for embodiments described in relation to FIGS. 5-15.

In some embodiments, FIG. 16 describes two architecturally distinct roles are performed by separate devices, i.e., the XR server and VR device. Although they roles are described as two distinct roles, they could be practiced by the same electronic device.

In one embodiment, the user may be using their live XR device 1610 during an XR session. The live XR device 1610 may include a sensor on the user or be connected to a device having sensor that is worn by the user. It may also include a sensor connected to its display. In another embodiment, the XR device may be connected to other external sensors on the world, i.e., sensors that are located anywhere except being worn on the body of the user. The external sensors and their corresponding capabilities (such as computer vision) may be accessed by the control circuitry.

In some embodiments, the user may be logging into their XR device to interact with the physical world around them. In certain scenarios, a sensor may be located both on the user as well as on the real world, such as fixated on an object in the room or on a wall. In this scenario, the XR device may send information relating to the user's biometrics and behavior as well as the real-life surroundings to XR server. The biometrics data may include eye gaze, heart rate, and speech of the user. Such biometric data may be used by the XR sever in determining whether an object that is being consumed by the user is of interest to the user. For example, if the user's heart rate includes or the gaze is fixated for a predetermined period of time on an object, then such biometric data may be interpreted as user interest in the object.

The reference objects datastore 1630 may store information extracted from the user's biometrics and behavior as well as the real-life surroundings. In particular, it may represent the real-life objects recognized in the scenes that the user experienced along with the associated interactions with such objects. That is, the user directly interacted with the real-life object, also referred to herein as reference object, observed someone interacting with the reference object, or is closely connected within a first or second degree with a contact that has interacted with the reference object. Data relating to user biometrics may also be used to determine the level, depth, type, and nature of interaction with the reference object.

In some embodiments, the reference objects datastore 1630 may store metadata of reference objects. The metadata may also be obtained from external web services. The metadata may relate to interactions recognized from the real-life surroundings and sensors on the user that involve each object. For example, if a user sat on a sofa (reference object), metadata relating to such real-life interaction may be stored along with the reference object.

In some embodiments, as identified at 1650, the reference objects datastore 1630 receives a query, from the XR server. The query includes certain characteristics an interaction that are to be used by the reference objects datastore 1630 to determine if it stores a reference object that includes the shared characteristics identified and if the reference object had been interacted with by the user. The reference objects datastore 1630 determines the matching reference object and interaction and returns that reference object along with its metadata to the XR Server.

In some embodiments, the XR Server 1620 may determine what XR content is displayed to the user. The XR Server 1620 may receive the primary content from some external service. It receives the user's interactions with the XR content and identifies an initial object (and its metadata, i.e., characteristics) that the user interacts with or is interested in as well as the level of interest to the user. The XR Server 1620 queries the reference objects datastore 1630 by providing the initial object and its metadata. It constructs a representation of the received matching reference object and augments the XR content with that representation and displays it to the user.

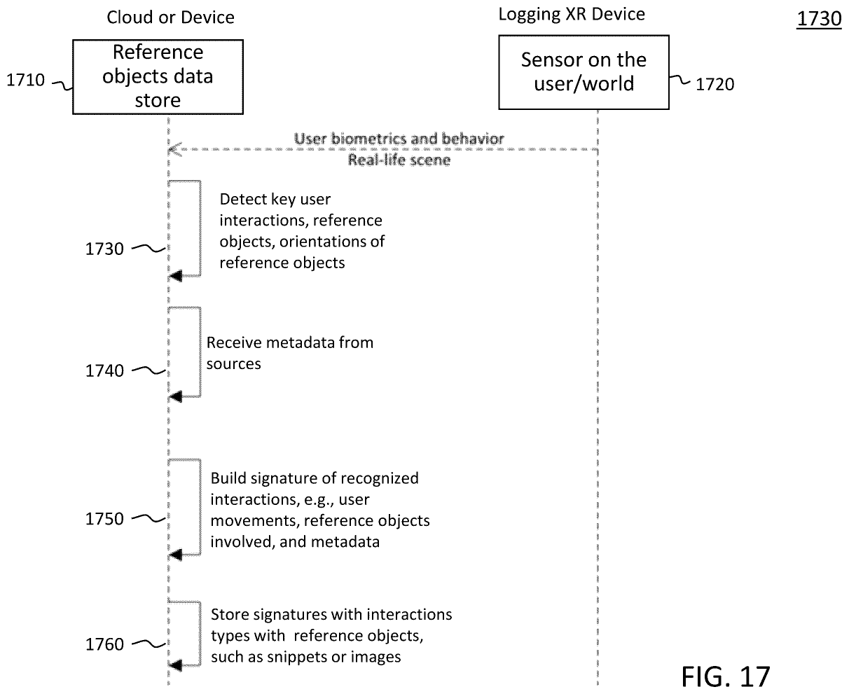

FIG. 17 is a flowchart of a method 1730 for building a reference object store, in accordance with some embodiments of the disclosure. The reference object store built using the method 1700 may be used by the control circuitry to select a reference object from the reference object store that is related to the initial object, such as based on the relevancy score of the reference object. For example, the reference objects selected in FIGS. 13-15 may be obtained by the control circuitry from the reference object store.

In some embodiments, user interactions with reference objects are determined by the XR device. Such determination may be based on receiving biomarker data, external device data, or user history, from sensors worn by the user or sensors on external devices.

In one embodiment, biomarker data, external device data from sensors worn by the user or external sensors 1720, is transmitted from the XR device to the reference objects data store 1710. Upon receiving the data, the reference objects data store 1710, at 1730 may detect key user interactions of the user as well as interaction of people that are connected to the user and participating in those interactions. These interactions may include gestures and poses. The control circuitry may also receive metadata from sources that includes the detected key user interactions. The metadata may include key orientations of the objects occurring in those interactions, e.g., those touched or moved by a person or another object. The control circuitry using the metadata may generate a signature of an interaction in terms of a sequence of the people and their motions and of the objects, their metadata, and their orientation. The control circuitry may store the generated signature with recognized interaction types with the reference objects, such as with a video snippet that includes the reference object.

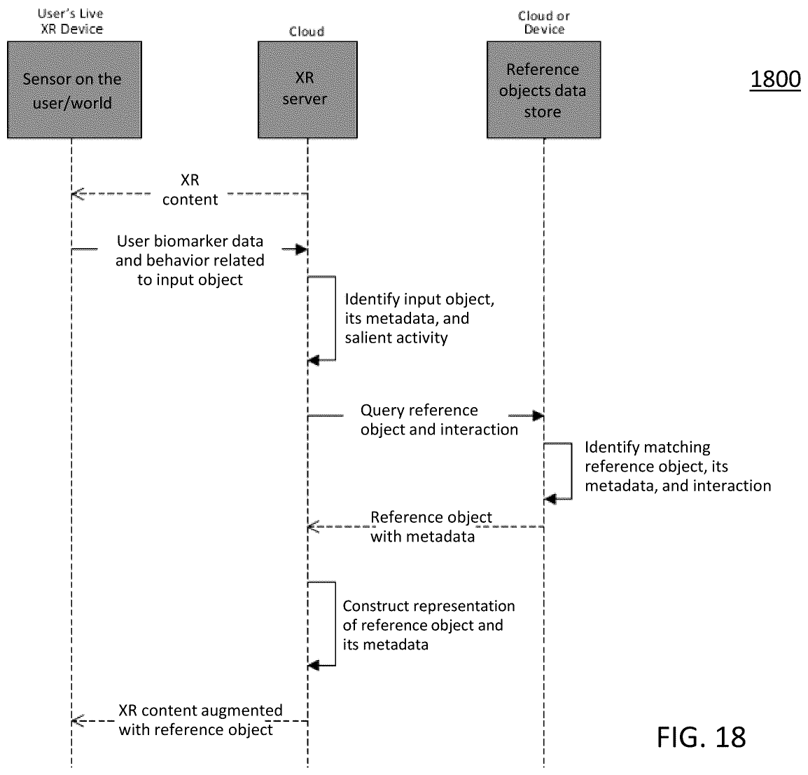

FIG. 18 depicts a block diagram for a method 1800 for communications between an objects datastore, an XR device (e.g., an example of the device 218 in an embodiment), and an XR server (e.g., an example of the server 202 in an embodiment), in accordance with some embodiments of the disclosure. The method 1800, for example, may be used to obtain biometric data of a user related to an input object and use such data to identify a reference object and augment the initial object as further described in the description related to FIGS. 1, 4, and 13-16.

In one embodiment, an XR server may send XR content to the XR device. The XR device may in return send biomarker data and behavior data related to an initial object to the XR server. The XR server may then identify initial object, its metadata, and any salient activity associated with the initial object. In some embodiments, the metadata for the initial object may be obtained from the virtual world description files. For example, in a virtual mall displaying clothes, the metadata would describe each article of clothing with its name, designer, fabric, size, dimensions, and so on.

The XR server may then query for a reference object with which a user has interacted. The query may be transmitted from the XR server to the reference objects data store. The reference objects data store may use the metadata provided to detect a reference object that shares characteristics with the initial object. In some embodiments, the control circuitry may perform activity recognition of interactions by determining whether an interaction with the reference object is the same (or similar to) as the representations constructed during indexing so as to facilitate search by matching the current query with the available index. Accordingly, key motions of the people participating in those activities (occurring in the video snippets), such as gestures and poses, key orientations of the objects occurring in those activities, e.g., those touched or moved by a person, or another object may be stored. The key motions may be used to generate a signature of an interaction in terms of a sequence of the people and their motions and of the objects, their metadata, and their orientation. The generated signature may serve as a query to find a relevant reference object. Upon searching the index, when a query comprising a signature of an interaction and shared characteristics with initial object is discovered, the control circuitry may identify the matching reference object as relevant to the initial object.

In some embodiments, the search may identify a preference for interactions and reference objects that occur frequently in the user's experience. In another embodiment, the search may identify a preference interaction and reference object that occurred recently in the user's experience. The time period could be preset with the bound configured, e.g., by the user. In yet another embodiment, the search may be based on interaction that is verbal to search directly in the database by activity name (for previously recognized activities) without having to build a signature.

Once the representation of construction of the reference object and its metadata is completed, the control circuitry may send the XR augmented content with the reference object to the XR device for display.

FIG. 19 is a block diagram of scoring engine 1900 for scoring a reference object, in accordance with some embodiments of the disclosure. The scoring engine 1900 and its processes may be implemented by a system (e.g., the system 200 shown in FIG. 2) to determine a relevancy score of a reference object.

In one embodiment, control circuitry of the system, such as the system in FIG. 2, may receive characteristics data related to an initial object 1910. The control circuitry may then use one or more characteristics to construct a search query. The search query may be used to search the reference object library 1920 for a reference object that shares the one or more characteristics of the search query. As depicted, in one embodiment, the control circuitry may identify four reference objects, i.e., reference objects A, B, C, and D 1930.

The identified reference objects may then be fed into a scoring engine 1950. The scoring engine may analyze each of the reference object based on a plurality of scoring criteria. In some embodiments the scoring engine may determine the type of characteristics that are matched between the reference object and the initial object. For example, if the type of characteristic is in the same genre or category, then a higher similarity score may be given as opposed to a characteristic that is generic, such as color of the object. In some embodiments, the scoring engine may determine the number or quantity of characteristics that match between the reference object and the initial object. For example, higher similarity score may be associated when a higher number of characteristics are matched. In some embodiments, the scoring engine may determine which capture device was used to capture the reference object. If a determination is made that the capture device used is either owned or operated by the user himself, then a higher user interaction score may be associated with such a reference object since there's a high probability that the user captured the reference object based on his interest. In some embodiments, the scoring engine may determine a degree of user interaction with the reference option. For example, was the user engaged more deeply with the reference object or was it an accidental glance at the reference object. Some examples of deeper interaction may include physical touching of the reference object, a user's gaze upon the reference object for a prolonged predetermined period of time, the frequency of use of the reference object by the user, and the overall familiarity of the reference object to the user. In some embodiments, if the interaction with the reference object is by the user himself then a higher user interaction score may be associated with such an interaction as opposed to the interaction being associated with contact of the user. Although few examples of types of user interaction score that may be calculated by the scoring engine are described, they are not so limited and other types of scoring based on different categories are also contemplated. Once scores are calculated for different categories, the control circuitry may determine a relevancy score based on all the calculated similarity and user interaction scores. The relevancy score may be an average, mean, standard deviation, or be based on some other identified formula. In some embodiments, based on the relevancy score, the control circuitry may rank the reference object in an order of the relevancy score as depicted at 1960. For example, reference object C may be ranked as the highest and as the most relevant reference object to the initial object. The control circuitry may the display object C on a display along with the initial object such that the reference object may give context to the initial object and allow the users to conceptualize the initial object.

It will be apparent to those of ordinary skill in the art that methods involved in the above-mentioned embodiments may be embodied in a computer program product that includes a computer-usable and/or—readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving an indication of an initial object being displayed on a display of an electronic device;
determining a set of characteristics of the initial object;
for each of a plurality of reference objects, calculating a relevancy score based on: (i) a degree to which the set of characteristics of the initial object is exhibited by the reference object; and (ii) a determined user interaction with the reference object;
selecting, from the plurality of reference objects, a selected reference object based on the calculated relevancy score for the selected reference object; and
displaying the selected reference object on the display of the electronic device.

2. The method of claim 1, wherein the user interaction is a capturing of an image of the reference object using the electronic device that is associated with a user.

3. The method of claim 2, wherein calculating the relevancy score includes rewarding the selected reference object in response to determining that the image of the reference object was captured by the electronic device associated with the user.

4. The method of claim 1, wherein calculating the relevancy score includes rewarding when a depiction of a user of the electronic device is included in a same image as the reference object.

5. The method of claim 1, wherein the initial object is a virtual object.

6. The method of claim 1, wherein the initial object is displayed via a live image viewed via a camera of the electronic device.

7. The method of claim 1, wherein the user interaction includes any one of 1) gaze of a user directed at the reference object, 2) selection of the reference object on a website, or 3) consumption of the reference object on a social media feed associated with a user.

8. (canceled)

9. (canceled)

10. The method of claim 1, further comprising, determining that the initial object is commercially available for purchase.

11. (canceled)

12. The method of claim 1, wherein the user interaction is an interaction with the reference object by a contact of a user of the electronic device.

13. The method of claim 1, wherein the user interaction is determined based on the reference object being stored in a photo-gallery of the electronic device associated with a user.

14. (canceled)

15. The method of claim 1, wherein calculating the relevancy score comprises:
determining a first weight for a similarity score representing the degree to which the set of characteristics of the initial object are exhibited by the reference object;
determining a second weight for a user interaction score determined based on the determined user interaction with the reference object; and
calculating the relevancy score based on the first weight, the similarity score, the second weight, and the user interaction score.

16. A system comprising:
communications circuitry configured to access an electronic device; and
control circuitry configured to:
receive an indication of an initial object being displayed on a display of the electronic device;
determine a set of characteristics of the initial object;
for each of a plurality of reference objects, calculate a relevancy score based on: (i) a degree to which the set of characteristics of the initial object is exhibited by the reference object; and (ii) a determined user interaction with the reference object;
select, from the plurality of reference objects, a selected reference object based on the calculated relevancy score for the selected reference object; and
display the selected reference object on the display of the electronic device.

17. The system of claim 16, wherein the user interaction is a capturing of an image of the reference object using the electronic device that is associated with a user.

18. The system of claim 17, wherein calculating the relevancy score includes, the control circuitry configured to reward the selected reference object in response to determining that the image of the reference object was captured by the electronic device associated with the user.

19. The system of claim 16, wherein calculating the relevancy score includes the control circuitry configured to reward when a depiction of a user of the electronic device is included in a same image as the reference object.

20. The system of claim 16, wherein the initial object is a virtual object.

21. The system of claim 16, wherein the initial object is displayed by the control circuitry via a live image viewed via a camera of the electronic device.

22. The system of claim 16, wherein the user interaction includes any one of 1) gaze of a user directed at the reference object, 2) selection of the reference object on a website, or 3) consumption of the reference object on a social media feed associated with a user.

23. (canceled)

24. (canceled)

25. The system of claim 16, further comprising, the control circuitry configured to determine that the initial object is commercially available for purchase.

26. (canceled)

27. The system of claim 16, wherein the user interaction is an interaction with the reference object by a contact of a user of the electronic device.

28. The system of claim 16, wherein the user interaction is determined, by the control circuitry, based on the reference object being stored in a photo-gallery of the electronic device associated with a user.

29. (canceled)

30. The system of claim 16, wherein calculating the relevancy score comprises,
the control circuitry configured to:
determine a first weight for a similarity score representing the degree to which the set of characteristics of the initial object are exhibited by the reference object;
determine a second weight for a user interaction score determined based on the determined user interaction with the reference object; and
calculate the relevancy score based on the first weight, the similarity score, the second weight, and the user interaction score.
